(19) United States
(12) Patent Application Publication
(10) Pub. No.: US 2023/0035413 A1
(43) Pub. Date: Feb. 2, 2023

(54) SYSTEMS AND METHODS FOR USE IN APPLICATION OF TREATMENTS TO CROPS IN FIELDS

(71) Applicant: CLIMATE LLC, San Francisco, CA (US)

(72) Inventors: Vera BULAEVSKAYA, Oakland, CA (US); Laura HESS, Albany, CA (US); Christopher HWANG, St. Louis, MO (US); Ricardo LEMOS, San Francisco, CA (US); Hunter MERRILL, Saint Charles, MO (US); Shilpa SOOD, Apex, NC (US); Liwei WEN, Daly City, CA (US)

(21) Appl. No.: 17/866,028

(22) Filed: Jul. 15, 2022

Related U.S. Application Data
(60) Provisional application No. 63/222,826, filed on Jul. 16, 2021.

(51) Int. Cl. G06Q 50/02; A01G 7/06

(52) U.S. Cl. CPC G06Q 50/02; A01G 7/06

(57) ABSTRACT

Systems and methods are provided for use in applying treatments to crops in fields. One example computer-implemented method includes calculating a growth stage of a crop in a field on a defined date based on planting data and weather data for the field and/or crop, and then, in response to the growth stage being within a spray window for the crop, defining a plurality of synthetic sprays within the spray window for the field. The method then includes, for each one of the synthetic sprays, calculating at least one disease risk for the crop in the field and calculating a response to the synthetic spray. The method then further includes compiling a report including a selected one or more of the responses, based on yield differences of the responses, as a recommendation for applying the treatment to the crop consistent with the synthetic spray associated with the selected one or more of the responses.

### CROSS-REFERENCE TO RELATED APPLICATION

This application claims the benefit of, and priority to, U.S. Provisional Application No. 63/222,826, filed Jul. 16, 2021, the entire contents of which is hereby incorporated by reference.

### FIELD

The present disclosure generally relates to systems and methods for use in applying one or more treatments to crops in fields, or growing spaces, and in particular, to systems and methods for use in application of one or more treatments, at one or more times, to crops planted in fields, based on modeling of data associated with application windows of the one or more treatments to the crops in the fields.

### BACKGROUND

This section provides background information related to the present disclosure which is not necessarily prior art.

It is known for seeds to be grown in fields for commercial purposes, whereby the resulting plants, or parts thereof, are sold by the growers for business purposes and/or profit. In connection therewith, the seeds are planted in the fields, and then crops from the seeds are harvested from the fields at a later time. In the interim, the fields (and seeds/crops) are subject to various conditions. The conditions may be nature conditions (e.g., rainfall, temperature, etc.), or conditions imposed by the growers associated with the fields (e.g., pesticides, fertilizer, irrigation, etc.). The introduction of the conditions, by growers, for example, is known to impact the growth of the seeds in the fields, and as a result, the overall yield of the crops from the fields, which in turn impacts an amount of crops available for sale for business purposes and/or profit.

### SUMMARY

This section provides a general summary of the disclosure, and is not a comprehensive disclosure of its full scope or all of its features.

Example embodiments of the present disclosure generally relate to methods (e.g., computer-implemented methods, etc.) for use in applying treatments to crops in one or more fields (e.g., for providing computer-implemented assistance in planning a treatment and/or in generating instruction scripts for conducting a treatment to crops in one or more fields, etc.). In one such embodiment, a method generally includes receiving, at a computing device, a request to recommend an application of a treatment for a field, the field including a crop, which is associated with a planting date indicative of a day the crop was planted, the request including a field ID for the field, and accessing a data structure including planting data and weather data for the field. The method also includes calculating, by the computing device, a growth stage of the crop in the field on a defined date, via a phenology model, based on the planting data and weather data included in the data structure, the growth stage indicative of a thermal time associated with the crop as defined by multiple temperatures associated with the field from about the planting date to about the defined date; determining, by the computing device, whether the calculated growth stage is within a window (e.g., a spray window, etc.) for the crop; and in response to the growth stage being within the window, defining a plurality of synthetic sprays (broadly, synthetic treatments) within the window for the field. The method then includes, for each one of the plurality of synthetic sprays: (i) calculating, by the computing device, at least one disease risk for the crop in the field, based on at least one disease risk model, the at least one disease risk indicative of a potential occurrence and/or a severity of at least one disease; and (ii) calculating, by the computing device, a response to the synthetic spray, via a response model, based on the calculated at least one disease risk and the growth stage of the crop in the field, wherein the calculated response includes a yield difference between a predicted crop yield for the crop subject to the synthetic spray and the predicted crop yield for the crop without the synthetic spray. The method then further includes compiling, by the computing device, a report including a selected one or more of the calculated responses, based on the yield differences of the responses, as a recommendation for applying the treatment to the crop consistent with the synthetic spray associated with the selected one or more of the calculated responses, and transmitting the report in response to the request.

Example embodiments of the present disclosure also generally relate to systems for use in identifying treatments for crops in one or more fields. In one such embodiment, a system generally includes a data structure having planting data and weather data stored therein and associated with multiple fields, and at least one computing device coupled in communication to the data structure. The at least one computing device is configured to receive a request to recommend an application of a treatment for a field, the field including a crop, which is associated with a planting date indicative of a day the crop was planted, the request including a field ID for the field, and access the planting data and the weather data for the field in the data structure. The at least one computing device is also configured to calculate a growth stage of the crop in the field on a defined date, via a phenology model, based on the planting date and weather data included in the data structure, which is indicative of a thermal time associated with the crop as defined by temperatures associated with the field from about the planting date to about the defined date, and determine whether the calculated growth stage is within a window (e.g., a spray window or treatment window, etc.) for the crop. The at least one computing device is further configured to, in response to the growth stage being within the window, define a plurality of synthetic sprays (broadly, synthetic treatments) within the spray window for the field and, for each one of the plurality of synthetic sprays: (i) calculate at least one disease risk for the crop in the field, based on at least one disease risk model, the at least one disease risk indicative of a potential occurrence and/or a severity of at least one disease; and (ii) calculate a response to the synthetic spray, via a response model, based on the calculated at least one disease risk and the growth stage of the crop in the field, wherein the calculated response includes a yield difference between a predicted crop yield for the crop subject to the synthetic spray and the predicted crop yield for the crop without the synthetic spray. The at least one computing device is then configured to compile a report including a selected one or more of the calculated responses, based on the yield differences of the responses, as a recommendation for applying the treatment to the crop consistent with the synthetic spray associated with the selected one or more of the calculated responses, and transmit the report in response to the request.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system of the present disclosure, which includes an agricultural computer system configured to perform one or more of the functions described herein in connection with one or more fields;

FIGS. 2A and 2B illustrate two views of an example logical organization of sets of instructions in main memory when an example application is loaded for execution;

FIG. 3 illustrates a programmed process by which the system of FIG. 1 generates one or more preconfigured agronomic model(s) using agronomic data provided by one or more data source(s);

FIG. 4 is a block diagram that illustrates an example computer system upon which one or more embodiments of the present disclosure may be implemented;

FIG. 5 illustrates an example implementation architecture that may be included and/or implemented in the agricultural computer system of FIG. 1, for use in performing one or more of the functions described herein;

FIGS. 6A and 6B illustrate example growing stages of winter wheat, and corresponding spray windows associated with the different growing stages, which may be use in connection with the system of FIG. 1;

FIG. 7 illustrates an example implementation of a phenology model, which may be used by the system of FIG. 1;

FIG. 8 illustrates an example implementation of a Septoria model, which may be used by the system of FIG. 1;

FIG. 9 illustrates an example implementation of a response model, specific to application of fungicide to one or more fields, in one or more spray windows, which may be used by the system of FIG. 1;

FIGS. 10A and 10B illustrate continuous risk plots, representative of risk to crops associated with temperature and relative humidity;

FIGS. 11A and 11B illustrates plots of predicted severity of disease to a crop over days from planting of the crop;

FIGS. 12A and 12B illustrate an example of feature engineering for input data for the response example model illustrated in FIG. 11;

FIG. 13 illustrates an example method for use in identifying a timing of an application of a treatment to a crop in a field, which may be implemented in the system of FIG. 1, based on modeling associated with the crop; and

FIG. 14 illustrates an example report that may be generated in the system of FIG. 1 and/or in the method of FIG. 13.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Application of treatments to crops at specific timing is a significant factor in the success of the treatment, and the ultimate yield of the crop. The appropriate time is understood to be based on certain factors, which, in general, typically involved human intuition and/or estimates as to the application. The reliance on human intuition and/or estimates, rather than specific measured features of the crops, injects imprecision and/or errors into the timing of the application of the treatments, often resulting in diminished yields from the crops and/or inefficient use of treatments. For example, for winter wheat, the growth of the crop defines, generally, three spray (broadly, treatment) windows, during which one or more fungicides may be sprayed. At each spray window, then, the grower makes a decision to spray or not spray, and then in the next spray window, the grower decides again, whereby after three spray windows, the grower has decided among eight different permutations of spraying or not, often with little or no feedback until end of season harvest as to whether the spray was successful or not. Each decision to spray, then, is a balance between unrealized benefit and the cost of the spray. The data potentially underlying the decisions to spray, or not, is expansive. That is, the number of factors, such as, for example, intersections with the phenology of the crops, predicted disease progression, and conditions of the field and/or surrounding environment (e.g., rainfall, temperature, humidity, soil, tillage, etc.), etc., define a problem and set of parameters impossible to be computed and/or processed in the human mind.

Uniquely, the systems and methods herein provide a solution for identifying timing with a spray (or treatment) window for application of one or more treatments (e.g., fungicides, etc.) to fields, based on data associated with the fields, and then for applying the one or more treatments to the fields consistent with the identified timing for better/improved impact, etc. In particular, an agricultural computer system is defined, which models the phenology of a crop, and also accounts for disease models, to predict a condition (or conditions) of the fields in certain windows of time. In this manner, then, the systems and methods herein may provide for implementing application of one or more treatments, at one or more times, to crops planted in fields, based on modeling of data associated with the fields.

As used herein, treatments generally refer to one or more substances to be applied (e.g., sprayed, delivered, etc.) to the one or more fields in order to enhance the growth of the crops in the fields and/or to inhibit negative impacts on the growth of the crops in the fields. As an example, fungicide treatments may be applied to crops in one or more particular windows of time.

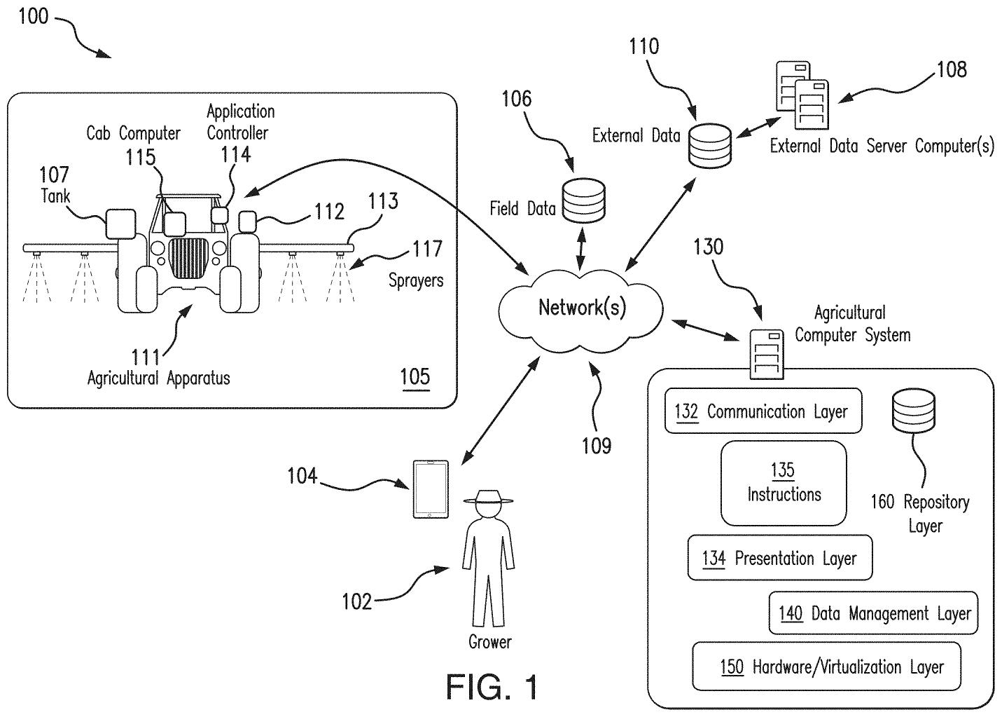

FIG. 1 illustrates an example system 100 configured to perform the functions described herein, shown in a field environment with other apparatus with which the system may interoperate. In one example embodiment, a user in the system 100 may be a grower 102, who owns, operates or possesses a communication device 104 (e.g., a field manager computing device, etc.) disposed at, from time to time, a location associated with one or more fields, including the example field 105, shown in FIG. 1. The fields are intended for use in connection with agricultural activities. The communication device 104 is programmed or configured to provide field data 106, which is associated with the one or more fields, to an agricultural computer system 130, via one or more networks 109.

Examples of field data 106 include (a) identification data (e.g., acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (e.g., crop type, crop variety, crop rotation, whether the crop is grown organically, harvest date, Actual Production History (APH), expected yield, yield, crop price, crop revenue, grain moisture, tillage practice, and previous growing season information), (c) soil data (e.g., type, composition, pH, organic matter (OM), cation exchange capacity (CEC)), (d) planting data (e.g., planting date, seed(s) type, relative maturity (RM) of planted seed(s), seed population), (e) treatment application data (e.g., fertilizer data (e.g., nutrient type (Nitrogen, Phosphorous, Potassium), application type, application date, amount, source, method) and/or chemical application (e.g., pesticide, herbicide, fungicide, other substance or mixture of substances intended for use as a plant regulator, defoliant, or desiccant, application date, amount, source, method, timing), (f) irrigation data (e.g., application date, amount, source, method), (g) weather data (e.g., precipitation, rainfall rate, predicted rainfall, water runoff rate region, temperature, wind, forecast, pressure, visibility, clouds, heat index, dew point, humidity, snow cover/depth, air quality, sunrise, sunset, etc.), (h) imagery data (e.g., imagery and light spectrum information from an agricultural apparatus sensor, camera, computer, smartphone, tablet, unmanned aerial vehicle, planes or satellite), (i) scouting observations (e.g., photos, videos, free form notes, voice recordings, voice transcriptions, weather conditions (e.g., temperature, precipitation (current and over time), soil moisture, crop growth stage, wind velocity, relative humidity, dew point, black layer)), and (j) soil, seed, crop phenology, pest and disease reporting, and predictions sources and databases, etc.

A data server computer 108 (or data server) is communicatively coupled to agricultural computer system 130 and is programmed or configured to send external data 110 to agricultural computer system 130 via the network(s) 109. The data server computer 108 may be owned or operated by the same legal person or entity as the agricultural computer system 130, or by a different person or entity such as a government agency, non-governmental organization (NGO), and/or a private data service provider, etc. Examples of external data include weather data, imagery data, soil data, or statistical data relating to crop yields, among others. External data 110 may consist of the same type of information as field data 106. In some embodiments, the external data 110 is provided by an external data server computer 108 owned by the same entity that owns and/or operates the agricultural computer system 130. For example, the agricultural computer system 130 may include a data server focused exclusively on a type of data that might otherwise be obtained from third party sources, such as weather data. In some embodiments, an external data server computer 108 may actually be incorporated within the system 130.

The field 105 may include, without limitation, any suitable growing space(s) for a crop (e.g., several acres, an acres, a plot, a greenhouse, etc.). The field 105 often includes several acres and is defined by boundaries. The field 105 is planted with specific seeds, as determined or selected by the grower 102, or another person associated with the field 105. The seeds grow into a crop on the field 105. The crop, in this example, may include wheat, and specifically, winter wheat. That said, other crops, such as, for example, maize, soybeans, barley, oat, cotton, canola, oilseed rape (OSR), etc., may be included in the field 105 in other embodiments.

As shown in FIG. 1, an agricultural apparatus 111 is disposed in the field 105, and may be configured, generally, to perform one or more operations at the field 105 (e.g., seed planting, application of treatment, harvesting, etc.). In this specific embodiment, the agricultural apparatus 111 is a sprayer apparatus, which is configured to apply one or more treatments to the field 105. In particular, for example, the sprayer apparatus includes one or more holding tanks 107 for a treatment and one or more sprayers 117 (e.g., sprayer nozzles, etc.), which are positioned on a boom 113 extending from each side of a cab to apply (e.g., spray, etc.) the treatment in a manner prescribed for the specific treatment, etc. It should be appreciated that the agricultural apparatus 111 may be of a different type of machine and/or configured otherwise in other embodiments. In addition, other agricultural apparatus may be included in the system 100, for example, in the field 105 or other fields, in other embodiments. Generally, examples of agricultural apparatus as used herein may include, without limitation, tractors, combines, harvesters, planters, trucks, fertilizer equipment, sprayers, aerial vehicles including unmanned aerial vehicles, and any other item of physical machinery or hardware, typically mobile machinery, and which may be used in tasks associated with agriculture.

In this example embodiment, as shown, the agricultural apparatus 111 in the system 100 may have one or more remote sensors 112 fixed thereon or coupled thereto, where the sensors are communicatively coupled either directly or indirectly via agricultural apparatus 111 to the agricultural computer system 130 and which are programmed or configured to send sensor data to agricultural computer system 130. In some embodiments, apparatus 111 may comprise a plurality of sensors 112 that are coupled locally in a network on the agricultural apparatus 111, where a controller area network (CAN) is an example of such a network that can be installed in combines, harvesters, sprayers, and cultivators. Application controller 114 is communicatively coupled to agricultural computer system 130 via the network(s) 109 and is programmed or configured to receive one or more scripts that are used to control an operating parameter of the agricultural apparatus 111 and/or implementation from the agricultural computer system 130. For instance, a CAN bus interface may be used to enable communications from the agricultural computer system 130 to the agricultural apparatus 111, for example, via the CLIMATE FIELDVIEW DRIVE, available from The Climate Corporation, San Francisco, Calif., etc. Sensor data may include the same type of information as field data 106. In some embodiments, remote sensors 112 may not be fixed to the agricultural apparatus 111, but may be remotely located in the field (e.g., the field 105, etc.) and/or may communicate with the agricultural apparatus 111 or the network 109 directly.

The agricultural apparatus 111 may further comprise a cab computer 115 that is programmed with a cab application, which may comprise a version or variant of the mobile application for communication device 104 (or otherwise) that is further described in other sections herein. In an embodiment, cab computer 115 may include a compact computer, often a tablet-sized computer or smartphone, with a graphical screen display, such as a color display, that is disposed and/or mounted within the cab of the apparatus 111. Cab computer 115 may implement some or all of the operations and functions that are described further herein for the communication device 104.

The network(s) 109 broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system may each comprise an interface compatible with the network(s) 109 and may be programmed or configured to use standardized protocols for communication across the networks (e.g., wide area network (WAN, local area network (LAN), mobile network, etc.)), such as, for example, TCP/IP, Bluetooth, CAN protocol and higher-layer protocols, such as, for example, HTTP, TLS, and the like.

Agricultural computer system 130 is programmed or configured to receive field data 106 from the communication device 104, external data 110 from external data server computer 108, and sensor data from remote sensor 112 (and/or other sensors). Agricultural computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural computer system 130 is programmed with or comprises a communication layer 132, a presentation layer 134, a data management layer 140, a hardware/virtualization layer 150, and a repository layer 160. “Layer,” in this context, refers to any combination of electronic digital interface circuits, microcontrollers, firmware such as drivers, and/or computer programs or other software elements.

In particular, the communication layer 132 may be programmed or configured to perform input/output interfacing functions including sending requests to the communication device 104, external data server computer 108, application controller 114, cab computer 115, and remote sensor 112 for field data, external data, and sensor data respectively. The communication layer 132 may be programmed or configured to send the received data to model and field data repository layer 160 to be stored as field data 106. And, the presentation layer 134 may be programmed or configured to generate a graphical user interface (GUI) to be displayed on the communication device 104, cab computer 115 or other computers that are coupled to the system 130 through the network 109. The GUI may comprise controls for inputting data to be sent to agricultural computer system 130, generating requests for models and/or recommendations, and/or displaying recommendations, notifications, models, and other field data.

The data management layer 140 may be programmed or configured to manage read operations and write operations involving the repository layer 160 and other functional elements of the system, including queries and result sets communicated between the functional elements of the system and the repository. Examples of data management layer 140 include JDBC, SQL server interface code, and/or HADOOP interface code, among others. The repository layer 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural computer system 130 via one or more agricultural machines or agricultural machine devices that interacts with the agricultural computer system 130, the grower 102 may be prompted via one or more user interfaces on the communication device 104 (served by the agricultural computer system 130) to input such information. In an example embodiment, the grower 102 may specify identification data by accessing a map on the communication device 104 (served by the agricultural computer system 130) and selecting specific CLUs that have been graphically shown on the map. In an alternative embodiment, the grower 102 may specify identification data by accessing a map on the communication device 104 (served by the agricultural computer system 130) and drawing boundaries of the field 105 over the map. Such CLU selection or map drawings represent geographic identifiers. In alternative embodiments, the grower 102 may specify identification data by accessing field identification data (provided as shape files or in a similar format) from the U.S. Department of Agriculture Farm Service Agency or other source via the communication device 104 and providing such field identification data to the agricultural computer system 130.

In an example embodiment, the agricultural computer system 130 is programmed or configured to generate and cause displaying of a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

In an example embodiment, the data manager provides an interface for creating one or more programs. “Program,” in this context, refers to a set of data pertaining to treatment applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering data relating to the same applications for multiple different fields, a user computer may create a program that indicates a particular application and then apply the program to multiple different fields.

In an example embodiment, model and field data is stored in the repository layer 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model generated or trained for analysis of past events on the one or more fields, a model generated or trained for analysis of the current status of the one or more fields, a model generated or trained for prediction of events on the one or more fields, and/or a model generated or trained for analysis of predicted events on the one or more fields (e.g., in comparison to current status, etc.). Model and field data may be stored in data structures in memory, rows in a database table, in flat files or spreadsheets, or other forms of stored digital data.

In an example embodiment, instructions 135 comprise a set of one or more pages of main memory, such as RAM, in the agricultural computer system 130 into which executable instructions have been loaded and which when executed cause the agricultural computer system 130 to perform the functions or operations that are described herein. For example, the instructions 135 may comprise a set of pages in RAM that contain instructions which when executed cause performing the spray timing recommendations that are described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 135 also may represent one or more files or projects of source code that are digitally stored in a mass storage device such as non-volatile RAM or disk storage, in the agricultural computer system 130 or a separate repository system, which when compiled or interpreted cause generating executable instructions which when executed cause the agricultural computer system 130 to perform the functions or operations that are described herein.

Instructions 135 comprise computer readable instructions which, when executed by one or more processors, cause agricultural computer system 130 to, for example, receive a request to recommend an application of a treatment for a crop in a field, where the crop is associated with a planting day indicative of the day the crop was planted and where the request includes a field ID for the field; access a data structure including planting data and weather data; calculate a growth stage of the crop in the field on a defined day, via a phenology model, based on the planting data and weather data included in the data structure, which is indicative of a thermal time associated with the crop as defined by temperatures associated with the field from about the planting date to about the defined date and by at least one stress factor for the field; determine whether the calculated growth stage is within a spray window for the crop; in response to the growth stage being within the spray window, define a plurality of synthetic sprays for the field, each of the synthetic sprays included within the spray window; for each one of the plurality of synthetic sprays: (i) calculate at least one disease risk for the crop in the field, based on at least one disease risk model, where the at least one disease risk is indicative of an occurrence and/or a severity of at least one disease, and (ii) calculate a response to the synthetic spray, via a response model, based on the calculated at least one disease risk and the growth stage of the crop in the field, wherein the response includes a yield difference between a predicted crop yield for the crop subject to the synthetic spray and the predicted crop yield for the crop without the synthetic spray; compile a report including a selected one of the responses, based on the yield differences of the responses, as a recommendation for applying the treatment to the crop consistent with the synthetic spray associated with the selected one of the responses; and/or transmit the report in response to the request.

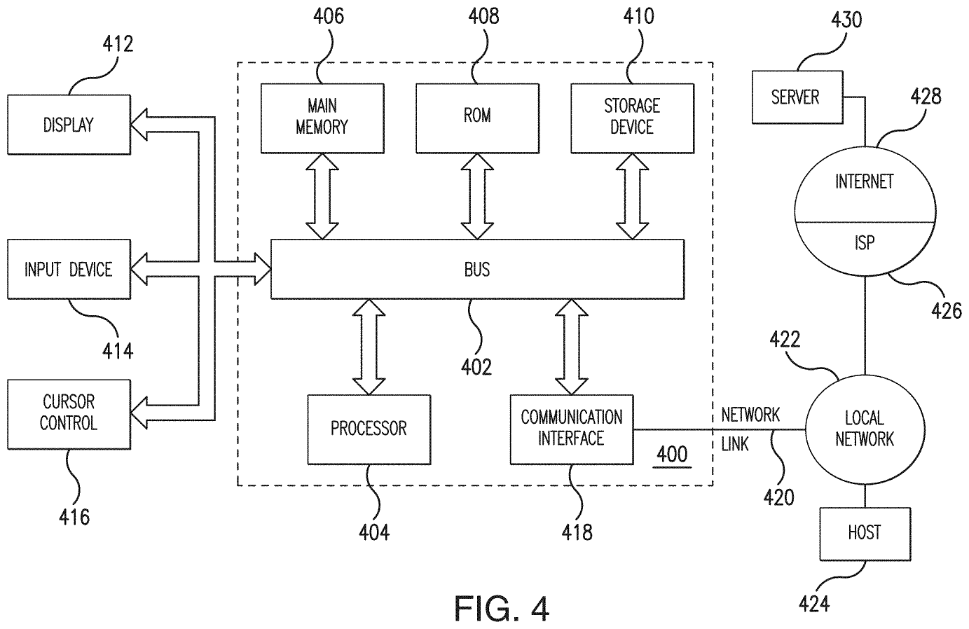

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different communication devices 104 associated with different users (including growers or other users in the system 100, etc.). Further, the agricultural computer system 130 and/or external data server computer 108 may be implemented using two or more processors, cores, clusters, or instances of physical machines or virtual machines, configured in a discrete location or co-located with other elements in a datacenter, shared computing facility or cloud computing facility.

In an example embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, the present disclosure is intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an example embodiment, the grower 102 interacts with agricultural computer system 130 using the communication device 104 configured with an operating system and one or more application programs or apps; the communication device 104 also may interoperate with the agricultural computer system 130 independently and automatically under program control or logical control and direct user interaction is not always required. The communication device 104 broadly represents one or more of a smart phone, PDA, tablet computing device, laptop computer, desktop computer, workstation, or any other computing device capable of transmitting and receiving information and performing the functions described herein. The communication device 104 may communicate via a network using a mobile application stored on the communication device 104, and in some embodiments, the device may be coupled using a cable or connector to the sensor 112 and/or controller 114. The grower 102 (or other user) may own, operate or possess and use, in connection with system 130, more than one communication device 104 at a time.

The mobile application may provide client-side functionality, via the network to one or more computing devices (e.g., a mobile computing device, a manager computing device, etc.). In an example embodiment, the communication device 104 may access the mobile application via a web browser or a local client application or app. The communication device 104 may transmit data to, and receive data from, one or more front-end servers, using web-based protocols or formats such as HTTP, XML and/or JSON, or app-specific protocols. In an example embodiment, the data may take the form of requests and user information input, such as field data, into the computing device. In some embodiments, the mobile application interacts with location tracking hardware and software on the communication device 104 which determines the location of the communication device 104 using standard tracking techniques such as multilateration of radio signals, the global positioning system (GPS), WiFi positioning systems, or other methods of mobile positioning. In some cases, location data or other data associated with the device 104, grower 102, and/or user account(s) may be obtained by queries to an operating system of the device or by requesting an app on the device to obtain data from the operating system.

In an example embodiment, the communication device 104 sends field data 106 to agricultural computer system 130 comprising or including, but not limited to, data values representing one or more of: a geographical location of the one or more fields, tillage information for the one or more fields, crops planted in the one or more fields, and soil data extracted from the one or more fields, etc. The communication device 104 may send field data 106 in response to user input from the grower 102 specifying the data values for the one or more fields. Additionally, the communication device 104 may automatically send field data 106 when one or more of the data values becomes available to the communication device 104. For example, the communication device 104 may be communicatively coupled to remote sensor 112 and/or application controller 114 which include a treatment. In response to receiving data indicating treatment of one or more fields, communication device 104 may send field data 106 to agricultural computer system 130 indicating that treatment was applied to the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it may, for example, combine historical data about the grower's fields with any other data that the grower desires to compare. The combinations and comparisons may be performed in real time, or not, and are based upon scientific models that provide potential scenarios to permit the grower to make better, more informed decisions, as described herein.

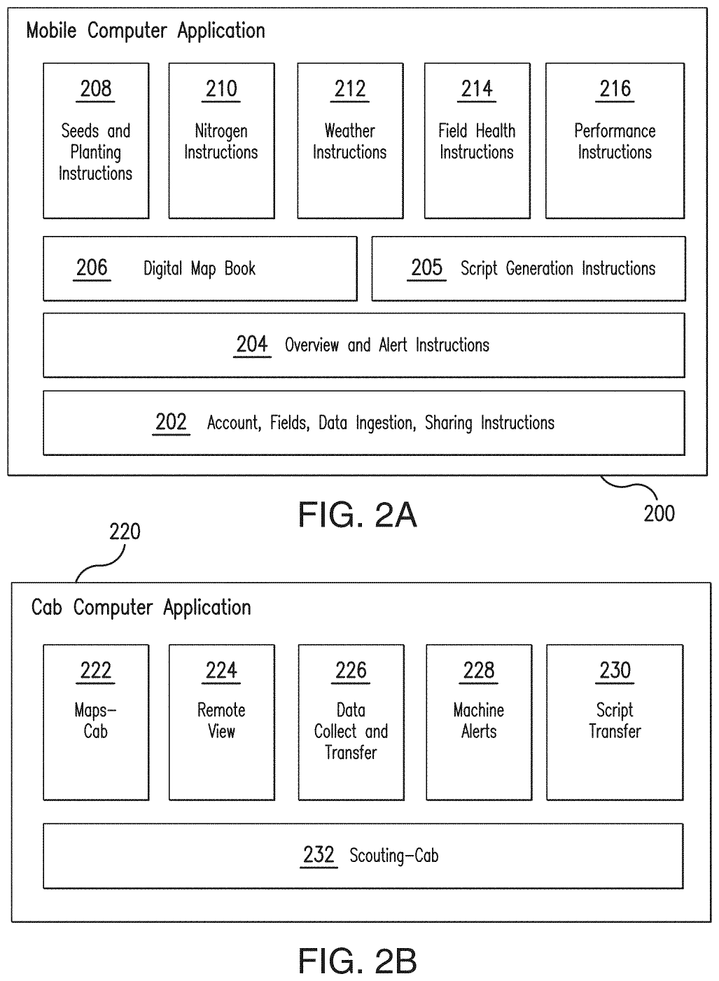

FIGS. 2A and 2B illustrate two views of an example logical organization of sets of instructions in main memory when an example mobile application is loaded for execution. In FIGS. 2A and 2B, each named element represents a region of one or more pages of RAM or other main memory, or one or more blocks of disk storage or other non-volatile storage, and the programmed instructions within those regions. In one embodiment, in FIG. 2A, a mobile computer application 200 comprises account, fields, data ingestion, sharing instructions 202, overview and alert instructions 204, digital map book instructions 206, seeds and planting instructions 208, treatment instructions 210, weather instructions 212, field health instructions 214, and performance instructions 216.

In one embodiment, a mobile computer application 200 comprises account, fields, data ingestion, sharing instructions 202 (broadly, data sharing instructions) which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to improve and/or maximize yield or return on investment through optimized seed purchase, placement and population.

In one embodiment, script generation instructions 205 are programmed to provide an interface for generating scripts for field implements, such as, for example, variable rate (VR) fertility scripts (e.g., for use in identifying field variability, creating management zones within a field, selecting treatment products, and/or assigning rates of treatment on each field; etc.). The interface enables growers (such as grower 102) to create scripts for field implements, such as treatments, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use.

In one embodiment, treatment instructions 210 are programmed to provide tools to inform/support treatment decisions by visualizing the availability of treatments to crops. This enables growers to improve and/or maximize yield or return on investment through the parameters of certain treatments (e.g., nitrogen, fertilizer, fungicides, other nutrients (such as phosphorus and potassium), pesticide, and irrigation, etc.) applied during the season. Example programmed functions include displaying images to enable drawing of application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable application(s) across multiple zones; output of scripts to drive machinery; tools for mass data entry and adjustment; and/or maps for data visualization, among others. In some examples, a report provided by the system 100 (as described herein) may be used to support generating one or more scripts for field implementation of treatments, recommendations, etc. included in the report.

“Mass data entry,” in this context, may mean entering data once and then applying the same data to multiple fields and/or zones that have been defined in the system; example data may include treatment application data that is the same for many fields and/or zones of the same grower, but such mass data entry applies to the entry of any type of field data into the mobile computer application 200. For example, treatment instructions 210 may be programmed to accept definitions of application and practices programs and to accept user input specifying to apply those programs across multiple fields. Treatment instructions 210 also may be programmed to generate and cause displaying a report (as generally described herein), a treatment graph, etc. which indicates recommendations, treatments, etc. to one or more fields, predicted impact to one of more field or treatment-related data for the one or more fields (e.g., growth stage graphs, etc.); in some embodiments, different color indicators may signal different treatments, volumes of treatments, etc. In one embodiment, a treatment graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each treatment applied or recommended.

In one embodiment, the treatment report, graph, etc. may include one or more user input features, such as dials or slider bars, to dynamically change the treatment programs so that a user may alter the treatment graph. In one embodiment, the treatment map may include one or more user input features, such as dials or slider bars, to dynamically change the treatment programs so that a user may alter his treatment map, such as to align with or deviate from a recommendation. The user may then use the treatment map and the related treatment programs to implement one or more scripts. In some embodiments, the treatment report, for example, may include a selected one or more calculated responses described herein, based on yield differences of the responses, as a recommendation for applying a particular treatment (or treatments) to a crop consistent with a synthetic treatment (e.g., spray, etc.) associated with the selected one or more of the calculated responses

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural computer system 130 and/or external data server computer 108 and configured to analyze metrics such as yield, yield differential, growth stage, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to FIG. 2B, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of FIG. 2B may be the same as for FIG. 2A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the system 130 based on the location of the communication device 104, agricultural apparatus 111, or sensors 112 in the field and ingest, manage, and provide transfer of location-based scouting observations to the system 130 based on the location of the agricultural apparatus 111 or sensors 112 in the field.

In an embodiment, external data server computer 108 stores external data 110, including soil data representing soil composition for the one or more fields and weather data representing temperature and precipitation on the one or more fields. The weather data may include past and present weather data as well as forecasts for future weather data (e.g., observed weather data, forecasted present and/or future data, climatology forecasted data, etc.). In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from the one or more fields. In an embodiment, application controller 114 is programmed or configured to receive instructions from agricultural computer system 130. Application controller 114 may also be programmed or configured to control an operating parameter of agricultural apparatus 111. In other embodiments, an application controller may be programmed or configured to control an operating parameter of another agricultural apparatus or vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The agricultural computer system 130 may obtain or ingest data under user control, on a mass basis from a large number of growers who have contributed data to a shared database system. This form of obtaining data may be termed “manual data ingest” as one or more user-controlled computer operations are requested or triggered to obtain data for use by the agricultural computer system 130. As an example, the CLIMATE FIELDVIEW application, commercially available from The Climate Corporation, San Francisco, Calif., may be operated to export data to agricultural computer system 130 for storing in the repository layer 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the grower 102 (or other user) via the cab computer 115 or other devices within the system 130. In this way, the type of crops in a field may be known, etc. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors to obtain grain moisture measurements in a combine or other harvester and transmit these measurements to the grower 102 (or other user) via the cab computer 115 or other devices within the system 130.

In an embodiment, examples of sensors that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying treatments (e.g., fertilizer, insecticide, fungicide, etc.), such as on-planter starter treatment systems, subsoil applicators, or treatment sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers (e.g., controller 114, etc.) that may be used with such apparatus (e.g., apparatus 111, etc.) include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors and controllers may be affixed to soil sampling and measurement apparatus that is configured or programmed to sample soil and perform soil chemistry tests, soil moisture tests, and other tests pertaining to soil. For example, the apparatus disclosed in U.S. Pat. Nos. 8,767,194 and 8,512,148 may be used, and the present disclosure assumes knowledge of those patent disclosures.

In an embodiment, sensors and controllers may comprise weather devices for monitoring weather conditions of fields. For example, the apparatus disclosed in published international application WO2016/176355A1, may be used, and the present disclosure assumes knowledge of that patent disclosure.

In an embodiment, the agricultural computer system 130 may be programmed or configured to create an agronomic model. In this context, an agronomic model is a data structure in memory of the agricultural computer system 130 that comprises field data 106, such as identification data, treatment data and harvest data for one or more fields. The agronomic model may also comprise calculated agronomic properties which describe either conditions which may affect the growth of one or more crops on a field, or properties of the one or more crops, or both (e.g., disease models, phenology models, yield response models, etc.). Additionally, an agronomic model may comprise recommendations based on agronomic factors such as crop recommendations, irrigation recommendations, planting recommendations, treatment recommendations, harvesting recommendations and other crop management recommendations. The agronomic factors may also be used to estimate one or more crop related results, such as agronomic yield. The agronomic yield of a crop is an estimate of quantity of the crop that is produced, or in some examples the revenue or profit obtained from the produced crop.

In an embodiment, the agricultural computer system 130 may use a preconfigured agronomic model to calculate agronomic properties related to currently received location and crop information for one or more fields. The preconfigured agronomic model is based upon previously processed field data, including but not limited to, identification data, harvest data, treatment data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

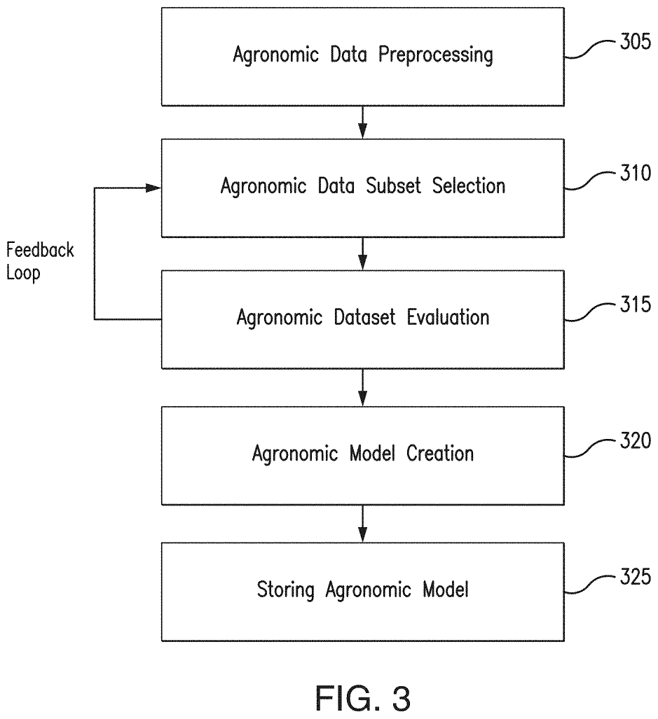

FIG. 3 illustrates a programmed process by which the agricultural computer system generates one or more agronomic models using field data provided by one or more data sources. FIG. 3 may serve as an algorithm or instructions for programming the functional elements of the agricultural computer system 130 to perform the operations that are now described.

At block 305, the agricultural computer system 130 is configured or programmed to implement agronomic data preprocessing of field data received from one or more data sources. The field data received from one or more data sources may optionally be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, data aggregation (e.g., feature engineering, etc.) and other filtering or data derivation techniques used to provide clear distinctions between positive and negative data inputs.

At block 310, optionally, the agricultural computer system 130 is configured or programmed to perform data subset selection using the preprocessed field data in order to identify datasets useful for initial agronomic model generation. The agricultural computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural computer system 130 is configured or programmed to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 310).

At block 320, the agricultural computer system 130 is configured or programmed to implement agronomic model creation based upon the datasets. In an embodiment, agronomic model creation may implement one or more of various techniques (e.g., multivariate regression techniques, random forest, LSTM, process modeling, etc.) to create the agronomic data models.

At block 325, the agricultural computer system 130 is configured or programmed to store the agronomic data models for future field data evaluation.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which one or more embodiments of the present disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), liquid crystal display (LCD), light emitting diode (LED), etc., for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device may, for example, have two degrees of freedom in two axes, a first axis (e.g., x, etc.) and a second axis (e.g., y, etc.), that allows the device to specify positions in a plane. The input device 414, more generally, includes any device through which the grower 102 (or other user) is permitted to provide an input, data, etc., to the computer system 400.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infrared data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

Spray Timing

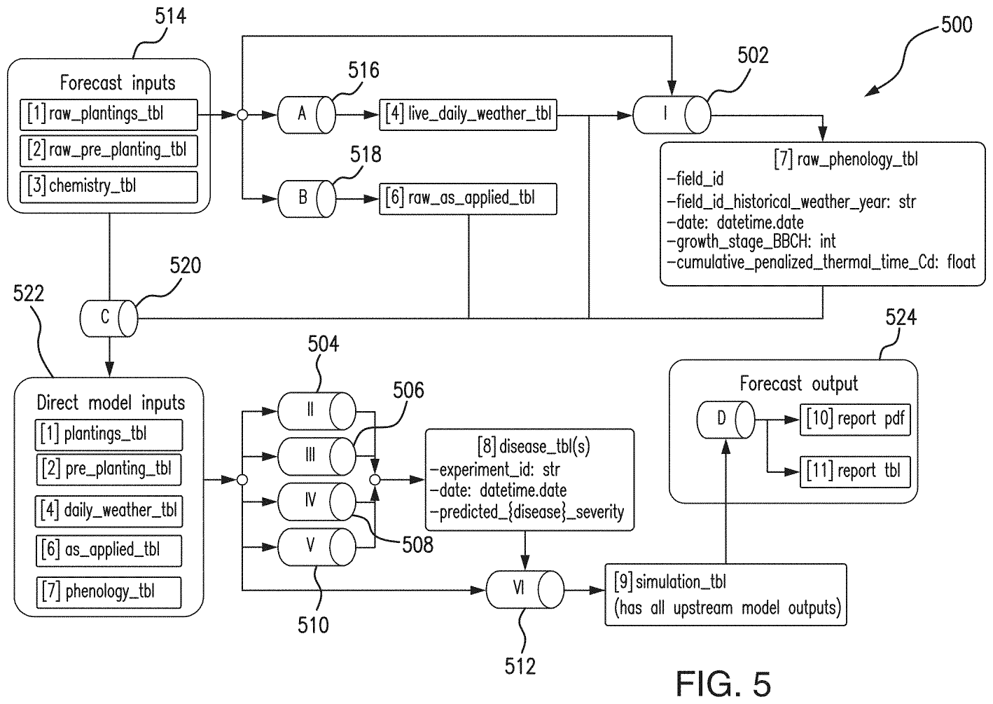

FIG. 5 illustrates an example architecture 500, which configures or programs the agricultural computer system 130 (e.g., through the models and instructions therein, etc.) to recommend the application of one or more treatments, such as, for example, fungicide, etc., to crops, at a specific time (or specific window), based on the different models included in the architecture 500.

In this example embodiment, specifically, the architecture 500 includes a number of models, which are dependent on data, as shown, from, for example, the field data 106 and/or the external data 110. Generally, the models include a phenology model configured to assess and/or predict the growth progression and/or stages of the crop, at least one disease model configured to predict an impact of one or more specific diseases on the crop, and a response model configured to predict the response of the crop, based on the phenology model and the disease model(s) for one or more hypothetical application(s) of the treatment (e.g. sprays, etc.), as compared to no application of the treatment. The models may vary in other embodiments (e.g., to include more or less disease models, etc.), but here, the architecture 500 generally includes a phenology model 502; four disease models: a Septoria model 504, a leaf rust model 506, a wheat stripe rust model 508, and a Fusarium model 510; and a response model 512.

It should be appreciated that the architecture 500 is specific to a recommendation for treatments (e.g., fungicide, etc.) to wheat, and in particular, the winter wheat planted in field 105 (e.g., located in a European region, etc.). For winter wheat in other embodiments, or in other regions, and/or for other crops, the type and/or number of models included in the architecture may be different. It should further be appreciated that the above phenology model 502 and the disease models 504-510 are trained on data relevant to a region in which the field 105 is located. For example, the field 105 may be located in Germany, and the training data for the above models may be limited to data for fields located in Europe (or to field having similar climate, conditions, etc.). It should be understood that the size of the region, for which the model is to be used, may be based on the volume of training data available for the region, or the uniformity of the conditions impacting response of the crop, etc. Stated another way, in one example, the more data that is available (or the more uniformity of the response), the more precise the model(s) can be built for the specific regions in which the field 105 is located.

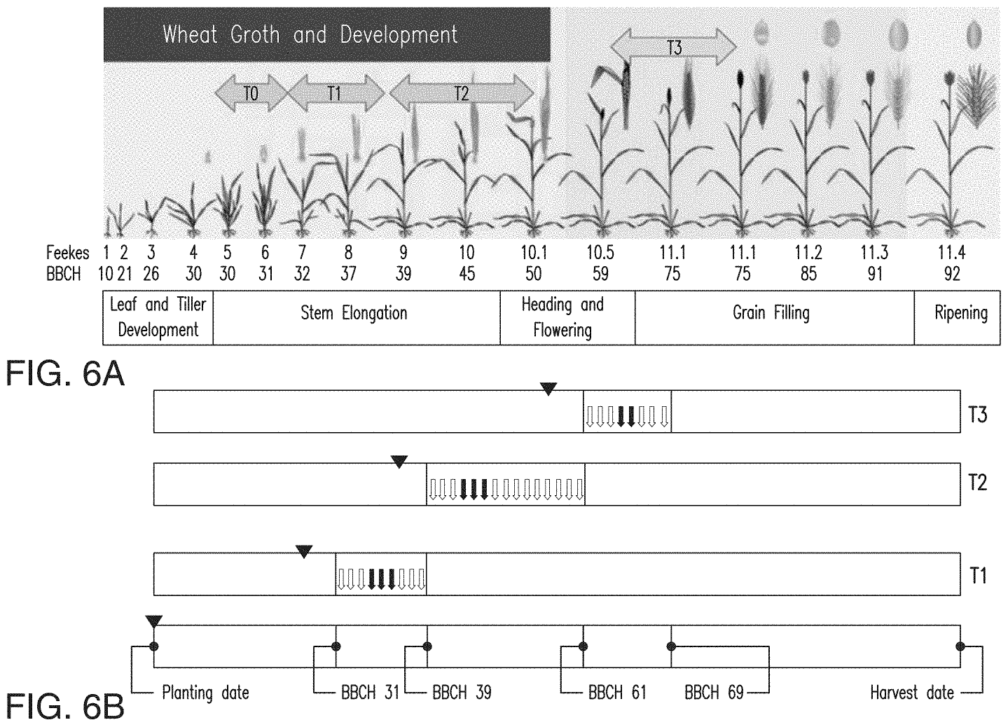

In general, as shown in FIGS. 6A and 6B, for example, a crop (in this example, winter wheat) is grown in a field, over a time between a planting of the seed and a ripening of the crop or harvest of the crop. In particular, FIG. 6A illustrates a growth stage diagram, which includes the growth stages of the winter wheat, as indicated by an index (e.g., BBCH, etc.), from planting of the seeds forward until ripening and harvest. As shown, in accordance with the index, the winter wheat progresses from leaf and tiller development, stem elongation, heading and flowering, grain flowering and ripening. It should be appreciated that the growth stage is a specific example for winter wheat and that other growth stages may be employed in other system embodiments, especially for other crops, in connection with phenology or otherwise.

In FIG. 6B, then, the growth stages of the winter wheat correspond to spray windows T1, T2 and T3, in which one or more treatments may be applied to the crop in the field 105. The spray windows, in this example, are defined by the growth stage of the crop. For example, the spray window T1 is defined between 31-39 BBCH; the spray window T2 is defined between 39-61 BBCH; and the spray window T3 is defined between 61-69 BBCH. It should be appreciated, like above, that the spray windows in FIGS. 6A and 6B are examples and should not be understood to limit the timing of number of spray windows for winter wheat of other crops, or to define all available or possible spray windows for use with the present disclosure.

That said, with reference again to FIG. 5, the agricultural computer system 130 is programmed or configured by the architecture 500 to recommend the crop in field 105 be sprayed (broadly, treated) on one or more specific days within one or more of the spray windows, as described in more detail below. In connection therewith, the architecture 500 includes an initial phase, in which the phenology model 502 is employed to determine a growth stage of the crop (as planted, growing, etc. within the field 105), and then a later phase, in which the growth stage of the crop is leveraged (or used as an input, etc.), by the other models, to predict the crop's response to multiple synthetic sprays at different dates within the spray window, depending on, at least in part, the predicted disease occurrence/severity, etc. (e.g., taking into account the particular growth stage of the crop, for example, at treatment, etc.), whereby a forecasted output is generated.

The architecture 500 also includes input data, which is provided to the phenology model 502. The input data for the forecast (e.g., forecast inputs 514, etc.) includes, specifically, raw planting data from the field data 106, or otherwise. The raw planting data, in turn, includes, for example, without limitation, field IDs (a unique identifier of the field 105, for example), locations (e.g., latitude and longitude, etc.), countries (e.g., 3-digit country code, etc.), planting dates, and field years (4-digit harvest year), etc. The phenology model 502 relies on additional data, including, specifically weather data. As such, as shown, the architecture 500 includes processing instruction 516, which configures the agricultural computer system 130 to leverage (or use, etc.) the raw planting data (e.g., of the forecast inputs 514, etc.), and in particular, the location and the planting date, to pull weather data (e.g., from the field data 106 and/or the external data 110, etc.) for the field 105, in this example. The output, as shown, is the daily weather for the field 105. The weather data may be, for example, in the form of daily weather for the field 105, or for other fields identified in the raw planting data. For example, the weather data may include the actual observed daily temperature for the field 105 from planting until a current day, and potentially, as needed, a daily temperatures of the field 105 going forward, based on an average daily temperatures for the last five years, eight years, (or more or less years) (i.e., climatology data), etc. In addition, the weather data may include forecasted weather data for five, seven, ten, fifteen, twenty-one, or more (or less) days, from a current day or a previous day, where the forecasted data is based on present or contemporaneous weather conditions at the field 105 and/or in the region(s) of and/or associated with the field 105 (i.e., not based on prior years). For example, the weather data may include actual observed data from a planting date to a day after the planting date, for example, eight days (or five days, or less) before a current day, forecasted weather for that day until ten days after a current day (i.e., eighteen total days), and then climatology weather data until a predicted harvest date or end of a season. The forecasted weather data may be received and/or retrieved from multiple sources of forecasted data, which may then be aggregated (e.g., summed, averaged, etc.) to define the daily temperatures, for example.

Also, the weather data may be limited by weather windows, whereby an interval of weather data may be employed. The weather windows may be specific to particular weather, whereby a weather window for temperature may be different than a weather window for precipitation. The weather windows may also vary depending on the particular model, whereby different models may rely on data from different weather windows (e.g., including specifically the Fusarium model 510, the rust models, and even the response model 512, etc.).

The architecture 500 also includes processing instruction 518, which configures the agricultural computer system 130 to identify prior applications of treatments to the field 105. In doing so, the agricultural computer system 130 leverages the raw plating data (e.g., of the forecast inputs 514, etc.) and captures data relating to application events of prior treatments for the field 105 (and potentially other fields), including chemistry and/or biological data associated with the treatment(s) (e.g., of the forecast inputs 514, etc.).

Phenology Model

Thereafter in FIG. 5, the architecture 500 configures or programs the agricultural computer system 130 to execute the phenology model 502 based on the raw planting data (e.g., of the forecast inputs 514, etc.) and the weather data (from processing instruction 516), for a current day for one or more fields (e.g., the field 105, etc.) (e.g., for calculating a growth stage of the crop in the field on a defined date based on the planting data and weather data included in the data structure, where the growth stage is indicative of a thermal time associated with the crop as defined by multiple temperatures associated with the field from about the planting date to about the defined date; etc.). The agricultural computer system 130 is configured or programmed to generate, by the phenology model 502, a raw phenology table, as an output, which includes, for example, without limitation, a field ID, historical weather year, and, for each date, growth stage, and thermal time (e.g., penalized thermal time in some examples, etc.), etc. The growth stage is expressed, in this embodiment, consistent with the BBCH index, whereby an integer from the BBCH index is assigned to indicate a developmental stage of the crop in the field 105 for that particular day. In connection therewith, daily thermal time may be calculated, for example, using a piecewise function with mean daily temperature as the input. The daily temperatures and/or the daily thermal time(s) may then be penalized by vernalization and photoperiod factors, for example, if the crop is between BBCH 5 and 30, etc. And, the daily thermal times, for each date, may in turn be summed (or cumulated or aggregated) to get a cumulative thermal time for the field 105.

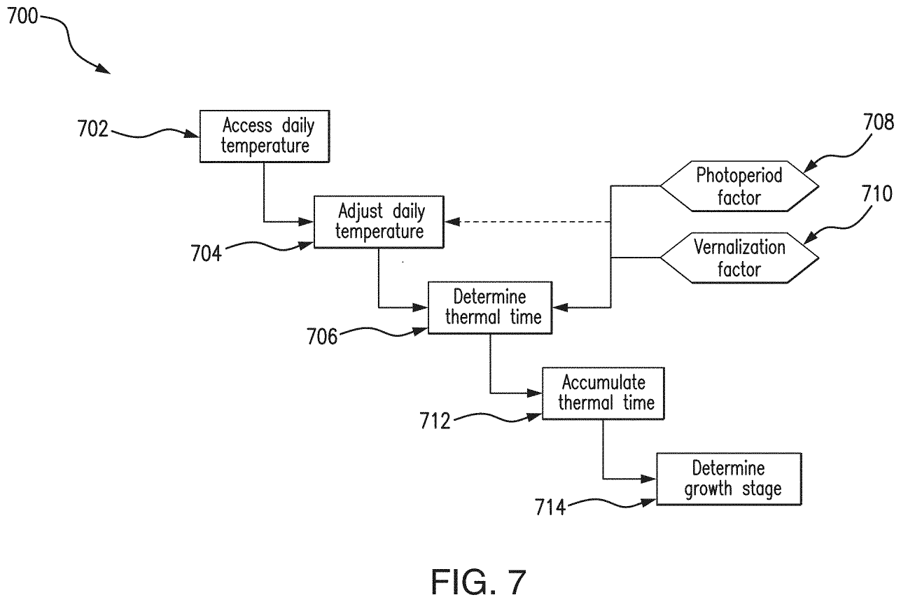

The phenology model 502, as indicated above, is configured to predict the growth stage of the crop, based on the above data. In connection therewith, FIG. 7 illustrates an example block diagram 700 of the phenology model 502, in which the growth stage is based on daily temperature and the illustrated adjustments. Specifically, for example, the daily temperature includes a daily temperature of a specific field (e.g., the field 105, etc.) for each day from planting until a current day. It should be appreciated that, through the phenology model 502, the growth stage of winter wheat, for example, is predicted through a cumulative thermal time of the field 105.

Initially, as shown in FIG. 7, the agricultural computer system 130 is configured or programmed to access, at 702, the air temperature for the field 105, for example, on a daily basis (as a daily temperature in the illustrated embodiment), or otherwise depending on the availability of weather data (e.g., based on observed weather data, climatology data, and/or forecasted weather data, etc.), etc. As indicated above, this data may include the daily temperatures for the field 105 for each day from planting in the field 105 until a current day.

At 704, the phenology model 502, then, configures or programs (or is implemented in) the agricultural computer system 130 to impose an adjustment or correction to the accessed air temperature(s) (on a daily basis for each day, etc.). In connection therewith, various example adjustments or corrections may be imposed via the phenology model 502 such as, for instance, adjustments or corrections based on snow cover in the field 105, shade cover (e.g., from trees, etc.), location of the field 105, soil type(s) within the field 105, vegetation cover, etc.

In one example, the phenology model 502 may configure or program the agricultural computer system 130 to impose a snow cover correction to each of the accessed air temperature(s), which is provided to account for the snow cover impact on the daily temperature of the field 105. The modified temperature is expressed below in Equation 1, where tempₐᵢᵣ is the air temperature, and snow is the depth of snow limited to a max value, which in this example, is about 15 centimeters (but may be otherwise in other examples). In applying the snow-cover correction, it should be appreciated that it may be assumed that there is no snow on the field 105 above freezing or 0° C., and that the phenology model 502 (in this example) does account for snow on the field 105 up to 5° C. to account for the presence of snow and/or the melting of snow above about 0° C.

temp_{corrected}=2+tempₐᵢᵣ*(0.4+0.0018*(snow−15)²) (1)

That said, application of the snow correction at 704 (and, more generally, application of the adjustment or correction at 704) may be optional in some embodiments and may also be omitted, for one or more reasons, including, for example, when the field 105 is located in a region not subject to snow covering after planting of the field 105, etc.

From the air temperature, or the corrected air temperature when utilized, the phenology model 502 configures or programs (or is implemented in) the agricultural computer system 130 to then determine thermal time, at 706 (on a daily basis, etc. for each of the daily accessed temperature(s)). Initially, Equation 2, below, provides an example thermal time function for use in determining the thermal time, where ΔTT is the thermal time, T is the input temperature (either air temperature or air temperature corrected for snow cover or corrected for any other desired basis), Tₒₚₜ is the optimum temperature, with a default value of 25° C., and Tₘₐₓ is the maximum temperature, with a default value of 45° C.

$$Δ TT = T , if 0 < T \leq {T}_{opt} \\ \frac{25}{9} ⋆ ( 34 - T ) , if {T}_{opt} < T \leq {T}_{max} \\ 0 , if T \leq 0 or T > {T}_{max} \qquad ( 2 )$$

Equation 3, below, provides another (or alternative) example thermal time function (as compared to Equation 2), where T is the input temperature (either air temperature or air temperature corrected for snow cover or corrected for any other desired basis), Tₗₒₚₜ is the lower optimum temperature, with a default value of 26° C., Tᵤₒₚₜ is the upper optimum temperature, with a default value of 50° C., and Tₘₐₓ is maximum temperature, with a default value of 60° C.

ΔTT=T, if 0<T≤TₗₒₚₜTₗₒₚₜ, if Tₗₒₚₜ<T≤Tᵤₒₚₜ −2.6T+156, if Tᵤₒₚₜ<T≤Tₘₐₓ 0, if T≤0 or T>Tₘₐₓ (3)

Equation 4 provides yet another (or further alternative) example thermal time function (as compared to Equations 2 and 3), where T is the input temperature (either air temperature or air temperature corrected for snow cover or corrected for any other desired basis), r is the daily rate of growth, Rₘₐₓ is the maximum rate of growth at Tₒₚₜ (where r/Rₘₐₓ is a value from 0-1), Tₒₚₜ is the desired or optimum temperature, with a default value of 25° C., Tₘₐₓ is the maximum temperature, with a default value of 39° C., and T_{base} is the base temperature, with a default value of 0° C.

$$Δ T T = T * \frac{r}{{R}_{max}} \frac{r}{{R}_{max}} = ( \frac{{T}_{max} - T}{{T}_{max} - {T}_{opt}} ) ( \frac{T - {T}_{b a s e}}{{T}_{opt} - {T}_{b a s e}} {)}^{\frac{{T}_{opt - {T}_{b a s e}}}{{T}_{max} - {T}_{opt}}} \qquad ( 4 )$$

It should be appreciated that Equations 2-4 are examples only, and that in other embodiments other thermal time functions may be used or implemented by the agricultural computer system 130, as configured by the phenology model 502, to determine thermal time (at 706 in the block diagram 700).

Regardless of the manner by which the thermal time is determined, the agricultural computer system 130 is programmed or configured, by the phenology model 502, to determine the thermal time (as above) and then to further account, in this embodiment, for the stress factors associated with growth of the winter wheat in the field 105. In particular, the thermal time may be adjusted or penalized (e.g., reduced, etc.) on a daily basis by, for example, a photoperiod factor, at 708, and a vernalization factor, at 710 (broadly, stress factors). Each factor is expressed, in this embodiment, as a value between 0 and 1, with the stress factor being 1 when there is no stress on the thermal units determined for the crop in the field 105. The thermal units for the crop may be determined based on daily temperatures for the crop (e.g., an average of the maximum and minimum temperature less (or times) a defined threshold; etc.). The stress factor may then be implemented in various manners, in connection with determining the thermal time, including, as described below in either Equation 5 or Equation 6 (where Equation 5 and Equation 6 are alternative options for implementing the stress factor effect on the adjusted temperature). In doing so, the photoperiod factor and the vernalization factor are applied to each daily thermal time (from 706), and the adjusted thermal times are then summed (or accumulated, etc.), at 712, for a desired period (e.g., from planting to a current day, etc.) to provide a cumulative thermal time ( [symbol] TT′). In this way, the phenology model 502 accounts for both the stress factors and the adjusted temperature(s).

[symbol]

TT′=Σ( [symbol] TT*min(fₚ, fᵥ)) (5)

[symbol]

TT′=Σ( [symbol] TT*fₚ*fᵥ) (6)

In connection with Equations 5 and 6, the photoperiod factor (fₚ) provides the stress to the crop based on short photoperiods (i.e., day lengths), which may slow the wheat phasic development, which is expressed in connection with winter wheat, in Equation 7 below, where C is the photoperiod constant (sensitivity to photoperiod), which is default to a value of 0.006, and P is the day length in hours (including civil twilight).

fₚ=1−C*(20−P)² (7)

In this example embodiment, winter wheat varieties may need, or require, exposure to relatively low temperatures before spikelet formation (i.e., the switch between vegetative and reproductive growth) is able to begin. This low temperature requirement for flowering of the winter wheat is referred to herein as vernalization and begins at germination. Equations 8-11, below, provide for determining the vernalization factor (fᵥ) employed in the phenology model 502, where in Equation 8, T is the input temperature (either air temperature or air temperature corrected for snow cover), T_{base} is the base temperature, which is default to a value of −5° C., Tₗₒₚₜ is the lower optimum temperature, which is default to a value of 0° C., Tᵤₒₚₜ is the upper optimum temperature, which is default to a value of 7° C., and Tₘₐₓ is the maximum temperature, which is default to a value of 15° C.

daily_vern=1+(0.2*T), if T_{base}<T≤Tₗₒₚₜ1, if Tₗₒₚₜ<T≤Tᵤₒₚₜ 1.875−0.125*T, if Tᵤₒₚₜ<T≤Tₘₐₓ 0, if T≤T_{base} or T>Tₘₐₓ (8)

It should be appreciated that devernalization may occur when daily maximum temperatures exceed 30° C. (or other suitable temperature) and the total accumulated vernalization days are less than 10. In this case, the number of vernalization days decreases by about 0.5 days per degree above 30° C., which is expressed in Equation 9 below, where Vᵢ₋₁ is the total accumulated vernalization and devernalization on the day prior to the current day, as defined in Equation 10. The vernalization factor (fᵥ), then, is defined in Equation 11, where P1V is the vernalization days (total accumulated vernalization) necessary for the max development rate to occur, with a default value of 8 (and where the vernalization factor is then usable in either of Equation 5 or Equation 6 above).

$${daily}_{-} d {evern}_{i} = min ( 0.5 ( {T}_{max} - 30 ) , {V}_{i - 1} ) when {T}_{max} > 30 °C and {V}_{i - 1} < 10 \qquad ( 9 )$$

$$V = {\sum }_{germination}^{floral - init} ( {daily}_{-} vern - {daily}_{-} devern ) \qquad ( 10 )$$

$$\begin{matrix}{f}_{v} = 0.4 + \frac{0.6 V}{P 1 V} & ( 11 )\end{matrix}$$

It should also be appreciated that the phenology model 502 may include, or not, further logic for different stages of the growth of the particular crop. For example, a thermal time between germination and emergence may be specifically calculated, as defined in Equation 12, where TTₑₘₑᵣ accounts for the thermal time (or stage) from germination to emergence, T_{lag} is the lag phase (which includes an initial period of fixed thermal time when emergence is slow), with a default value set to 40, rₑ is the rate of shoot elongation, with a default value of 8 thermal time units per cm, and S_{depth} is the sowing depth (cm), with a default value of 3. It should be appreciated that the thermal time expressed in Equation 12 is fixed.

TTₑₘₑᵣ=T_{lag}+rₑ*S_{depth} (12)

In the above description, the photoperiod factor and the vernalization factor are applied to each daily thermal time (from 706) to obtain a penalized daily thermal time. In other embodiments, the photoperiod factor and the vernalization factor may instead be applied to the daily temperatures, for example, as part of adjusting the daily temperatures at 704 (as indicted by the dotted line in FIG. 7, the penalized temperature is obtained). The daily thermal times may then be determined based on the adjusted/penalized daily temperatures, and accumulated, as described above.

Thereafter, in this example embodiment, the agricultural computer system 130 is configured or programmed to determine, at 714, a growth (or phenology) stage for the field 105 (in terms of BBCH or otherwise). For example, the agricultural computer system 130 may be configured or programmed to convert, at 716, the accumulated daily thermal times for the field to a growth stage. Table 1 illustrates an example conversion basis that may be employed by the agricultural computer system 130. In connection therewith, it should be appreciated that the thermal times identified in Table 1 are specific for each stage. As such, to achieve the first stage in Table 1, BBCH 5 (germination), the field 105 must have an accumulated daily thermal time (from 712) of at least 10. To achieve the second stage in Table 1, BBCH 10 (emergence), the field 105 must have an accumulated daily thermal time (from 712) of at least 74 (i.e., 10+64=74). To achieve the third stage in Table 1, BBCH 30 (terminal spikelet), the field 105 must have an accumulated daily thermal time (from 712) of at least 474 (i.e., 10+64+400−474). The same applies to each of the other stages in Table 1. It should be appreciated that the same or different, or more or less growth stages may be included in other phenology models. Additionally, different conversions may be employed for different geographic regions (e.g., for different countries, etc.). It should also be appreciated that while Table 1 is expressed in BBCH, a different index may be employed in other embodiments of the phenology model to identify a growth stage for a field (at 714) based on accumulated daily thermal times for the field. In some examples, computational models and algorithms for classification, such as neural networks, k-means or the like, trained for determination of growth stage based on thermal times may be used to convert, at 716, the accumulated daily thermal times for the field to a growth stage.

TABLE 1

| | | Additional thermal |
|---|---|---|
| Phenology | | time required to |
| stage | Phenology stage | advance to this stage |
| (BBCH) | (description) | from the previous stage* |
| BBCH 5 | germination | 10 |
| BBCH 10 | emergence | 64 |
| BBCH 30 | terminal spikelet | 400 |
| BBCH 31 | first node (start of T1 spray | 75.6 |
| | window) | |
| BBCH 32 | second node (end of T1 spray | 75.6 |
| | window) | |
| BBCH 37 | flag leaf visible | 75.6 |
| BBCH 39 | flag leaf fully emerged (start of | 75.6 |
| | T2 spray window) | |
| BBCH 45 | late boot stage | 63 |
| BBCH 51 | start of heading | 63 |
| BBCH 55 | middle of heading | 63 |
| BBCH 59 | end of heading | 63 |
| BBCH 61 | start of flowering | 50 |
| BBCH 65 | 50% flowering completed (start | 50 |
| | of T3 spray window) | |
| BBCH 69 | end of flowering | 50 |
| BBCH 51 | watery ripe | 50 |
| BBCH 75 | medium milk | 150 |
| BBCH 85 | soft dough | 150 |
| BBCH 89 | physiological maturity | 150 |
| BBCH 99 | harvest | 200** |

Referring again to FIG. 5, after the phenology model 502 has determined the growth stage of the one or more fields, including the field 105 for the current day, as explained above, the agricultural computer system 130 is configured or programmed, by instructions 520, to check the growth stage of the crop in the field 105, relative to one or more spray (or treatment) windows for the crop in the field 105 (e.g., as defined by the grower 102, as defined based on the crop in the field 105, as defined by a location of the field 105, as defined by a provider of seed used to grow the crop, as defined by a combination thereof, etc.). As shown in FIGS. 6A and 6B, for winter wheat, for example, the growth stage (and corresponding phenology) is associated with a number of spray windows for the field 105. Again, the spray windows are provided for illustration only, as the spray windows for winter wheat and other crops may vary depending on, for example, the particular crop, the region in which the crop is planted, etc. The agricultural computer system 130 is then configured or programmed to determine if the crop in the field 105, for example, based on the determined growth stage of the field 105 (e.g., by the phenology model 502, etc.) is within the spray window (or potentially, within an interval of the spray window (e.g., within five days of a spray window, etc.)). For example, where T1 is defined between BBCH 31 and BBCH 39, the agricultural computer system 130 may be configured or programmed to identify the field 105, as being within the spray window, when the BBCH is between BBCH 31-39, or within a number of days or an interval of BBCH 31-39. It should be appreciated that the spray windows, T1, T2, T3 are illustrated in FIGS. 6A and 6B as defined by growth stages of the winter wheat and may be otherwise in other embodiments.

When the field 105 is identified as within a spray window, the agricultural computer system 130 is configured or programmed to generate synthetic sprays (broadly, treatments) for the field 105, for each of various subsequent days (e.g., the next five days, the next ten days, the entire spray window, the remainder of the spray window, etc.). Synthetic sprays (or proposed sprays or hypothetical sprays) are illustrated in FIG. 6B as arrowed lines within the spray window. As shown, the different spray windows may be of different lengths, and consequently, may include a different number of synthetic sprays (depending on, for example, a current growth stage, a forecast interval, a grower preference, etc.). The synthetic sprays, as explained more below, are a specific designation of a treatment (e.g., fungicide, etc.) having a specific chemistry and/or biology on a specific day (e.g., within the spray window, etc.), which is an input to the models described below, in order to predict an impact associated therewith.

For example, in connection with implementing the architecture 500, on each desired day following planting (or otherwise), the phenology model 502 may be implemented (as described above) to identify a growth stage for the field 105 (and for each other desired field) in the next 7 days (i.e., for 7 days later than the current day). The processing instruction 520 may then configure the agricultural computer system 130, based on the identified growth stage, to perform a check to determine if a spray treatment has already been applied to the field 105 in connection with a spray window into which the field 105 is going to enter (or be in) in the next 7 days (e.g., based on the raw_as_applied_tbl data inputs in the architecture 500, etc.).

Then in this example, if the field 105 is entering a T spray window in 7 days (e.g., the T1 spray window, the T2 spray window, the T3 spray window, etc. in FIGS. 6A and 6B; etc.), and the field 105 has not yet been sprayed for that T spray window, the agricultural computer system 130 may be configured or programmed to generate one or more synthetic sprays, for example, as part of a synthetic spray table (e.g., identifying the field, date(s) within the T spray window, treatment scenarios, etc.), by making each date during the predicted T spray window a synthetic spray (e.g., again, as indicated by the arrows in FIG. 6B, etc.). Thus, for the T spray window in this example, there may be a total of n proposed spraying scenarios, where n is the number of days in the T spray window.

Alternatively, if the field 105 is not entering a spray window (e.g., the time is before T1 in FIGS. 6A and 6B, etc.), or the field 105 is entering a T spray window but the field 105 has already been sprayed for this T spray window, the agricultural computer system 130 may determine not to generate any synthetic sprays in the first instance.

Once the synthetic sprays are generated, when determined that the sprays should be generated, the agricultural computer system 130 is programmed or configured to access additional input data and to proceed to execute each of the disease models 504, 506, 508 and/or 510 to predict disease risk for the field 105 based on a control (e.g., as untreated, as treated conventionally, etc.) and the synthetic sprays (e.g., as treated with the synthetic sprays, etc.). In particular, the agricultural computer system 130 is programmed or configured to access input data 522, including planting table data, which includes, for example, the field ID of the field 105, for example, an experiment ID (which is specific to the synthetic spray (e.g., date, fungicide chemistry, etc.), a location of the field 105 (e.g., latitude, longitude, etc.), country code, planting date, harvest date, year, etc. The agricultural computer system 130 is further programmed or configured to access pre-planting data (as part of the input data 522), which include, without limitation, a field ID, a field ID for unique historical data, weather by year, experiment ID, data for a previous crop in the field, tillage method for the year, and plant variety, etc. The agricultural computer system 130 is also programmed or configured to access daily weather data (as part of the input data 522), which includes, without limitation, a field ID, field ID for unique historical data for the field, weather by year, experiment ID, location, date, number of days after planting, daily weather variables, and risk values for crop-specific diseases. With regard to the risk values for crop-specific diseases, for instance, each crop may have a specific risk value for a disease at a given temperature (e.g., for wheat leaf rust, the risk value for the day may be based on hourly weather data for a prior 24 hour period; etc.).

The agricultural computer system 130 is programmed or configured to also access applied data (as part of the input data 522), which includes, without limitation, field ID, experiment ID, data of treatment applied, growth stage at application (e.g., BBCH, etc.), a synthetic bool (e.g., a flag indicating whether an application event is from real grower applications (synthetic=False) or synthetically generated (synthetic=True), etc.), the treatment applied, the chemistry of the treatment, and the dosage of the treatment applied to the field (e.g., in kilogram (kg) active product per hectare (ha), etc.), a previous crop in the field, tillage method for the year, and plant variety, etc. And, the agricultural computer system 130 is programmed or configured to access the phenology output for the field 105 (e.g., from the phenology model 502, etc.) (as part of the input data 522). It should be appreciated that rather than accessing the output of the phenology model 502, the agricultural computer system 130 may be configured or programmed to execute the phenology model 502, again, along with the disease models.

It should be appreciated that the input data to the models is example, and may be otherwise in other embodiments, depending on, for example, the data upon which the models are built. It should also be appreciated that the input data may be in any suitable form. For example, the input data may be processed by the agricultural computer system 130, whereby the input data includes combinations of input data (e.g., as defined by feature engineering, etc.). The specific models below illustrate different combinations of input data, and others should be understood to be within the scope of the present disclosure.

Next, the agricultural computer system 130 is programmed or configured to execute the specific models, based on the input data, as described herein. It should be appreciated that the model(s) may be executed, by the agricultural computer system 130, in parallel and/or sequentially, depending on, for example, available processing resources, time constraints, etc.

Septoria Model

The Septoria model 504 configures or programs (or is implemented in) the agricultural computer system 130 to determine a daily severity risk of Septoria disease, for example, for winter wheat (or other crop) in the field 105, from the current date forward for a given year. The severity risk of Septoria may be provided on any desired scale, for example, low, medium, high, etc.

The model is based on various features associated with the crop and/or the field 105, which may be dependent on the type of modeling initially employed to build the model. Optionally, the Septoria model 504 may be built based on, at least, random forest, long short-term memory (LSTM), and/or process model techniques, or a combination/ensemble of any of these methods. Each of the different modeling techniques may be subject to the same or different data features (from the input data and/or feature engineering), upon which the model is then able to predict the Septoria risk. Example data features, that may be employed in each of the above modeling techniques, are listed in Table 2 below. In addition to the above, the Septoria model 504 may rely on the planting date of the field 105, the location of the field 105, for example, to derive data features of the model (e.g., location combined with weather data, etc.).

TABLE 2

| | | Example Data |
|---|---|---|
| Example Data Features in RF | Example Data Features | Features process |
| model | LSTM model | model |
| accumulated temperature risk | Daily mean | Temperature (daily |
| accumulated precipitation risk | temperature | mean) |
| accumulated relative humidity | Daily mean relative | Precipitation (daily |
| risk | humidity | total) |
| accumulate condensation risk | Daily sum | Relative humidity |
| accumulate max rainrate | precipitation | (daily mean) |
| longitude/latitude | Fungicide (application | Fungicide |
| Days after planting at assessment | date) | (application date) |
| Days after last application | Crop_stage_at_appl | |
| Crop stage | | |
| Frac_7_days_after_planting_appl | | |
| frac_3_days_after_planting_appl | | |
| total_dose | | |

In this example embodiment, the Septoria model is built through use of long short term memory (LSTM) units, and as such, is based on the data features including, without limitation, daily mean temperature, daily mean relative humidity, daily sum of precipitation on the field 105 (e.g., since planting, etc.), whether a treatment (e.g., fungicide, etc.) has been applied and the application date relative to the growth stage (and potentially, the chemistry and/or ingredients of the treatment), if applied, other phenology observations of the field 105 and/or crop in the field 105, etc. In particular, in one or more example embodiments, the relevant data from untreated fields may be included in training data, especially, for early growth stages which are prior to application of fungicides, for example.

Based on the above, the agricultural computer system 130 is configured or programmed, by the Septoria model 504, to determine a daily severity risk of Septoria infection in the crop in the field 105, for each of the synthetic sprays identified above.

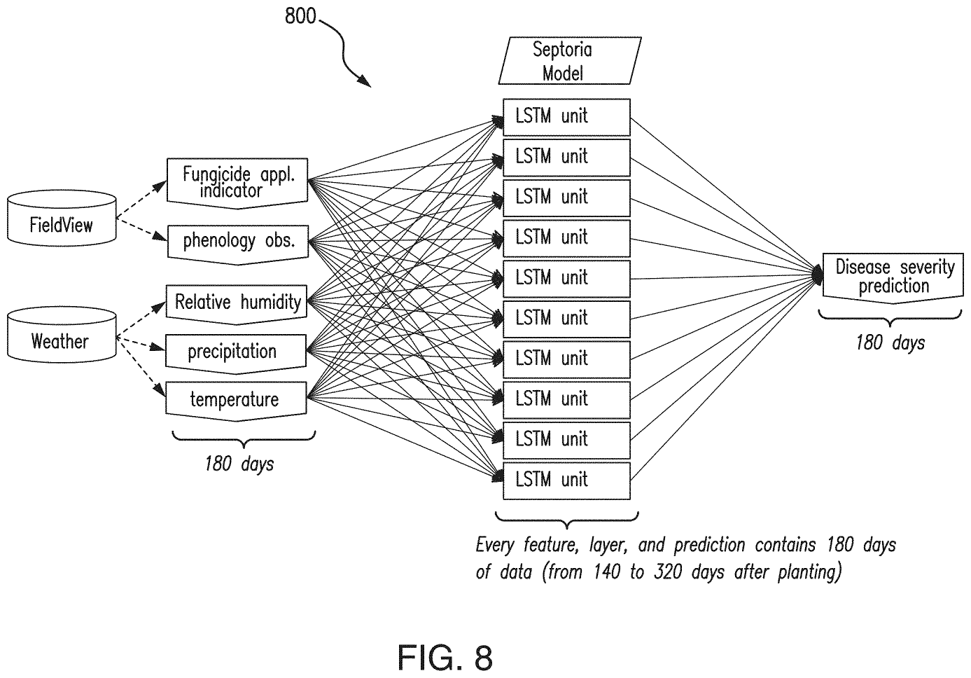

FIG. 8 illustrates an example block diagram 800 of the Septoria model 504 based on the above. As described, the Septoria model 504 configures or programs (or is implemented in) the agricultural computer system 130 to access field data such as prior treatments for the field 105 and phenology observations (e.g., for the last 180 days, for the 180 days ranging from 140 days after planting to 320 days after planting, for another range of dates and/or time frame of dates, etc.), and weather data such as relative humidity, precipitation, and temperature (e.g., for the last 180 days, etc.). Multiple LSTM units (or networks) then operate on the data to determine the severity risk of Septoria disease for the field 105. In connection therewith, at each time step, each of the LSTM units combines the input features from the current time step as well as the output features from the LSTM units from the previous time step and processes the input features and output features with mathematical operations (e.g., element-wise multiplication, addition, and sigmoid and hyperbolic tangent functions, etc.) to create the output for the current time step.

It should be appreciated that, while the severity of Septoria is determined through the Septoria model 504 in this embodiment, the occurrence of Septoria may also, or alternatively, be determined through a different version(s) of the model, and combined, and then used to determine a predicted response as described below.

Leaf Rust Model

Referring again to FIG. 5, the leaf rust model 506 configures or programs (or is implemented in) the agricultural computer system 130 to determine a daily severity risk of leaf rust (or brown rust) disease, for example, for winter wheat (or other crop) in the field 105, from the current date forward for a given year. The severity risk of leaf rust may be provided on any desired scale, for example, low, medium, high, etc.

Like above, the leaf rust model 506 is based on various features associated with the crop and/or the field 105, which may be dependent on the type of modeling initially employed to build the model. Optionally, the leaf rust model may be built based on, at least, random forest and/or LSTM techniques and/or Gaussian processes. Each of the different modeling techniques may be subject to the same or different data features (from the input data), upon which the model is then able to predict the leaf rust risk.

In this example embodiment, the leaf rust model 506 is defined based on the random forest model, which is dependent on temperature and the relative humidity. That said, it should be appreciated that other feature data may form the basis for the leaf rust model in other embodiments, including, without limitation, other weather data, fungicide applications (e.g., chemistry, date, etc.), genetic disease susceptibility, soil data, topographic data, tillage data, rotation data, irrigation data, etc. With respect to the leaf rust model 506, for the specific data herein, the model relies on the temperature risk where the risk has a value, for example, on an hourly or other interval basis, as represented by Equation 13. In some examples, the temperature risk may have a value of 1 in a specific temperature range (e.g., between about 15° C. and about 25° C., etc.), and a value of 0 otherwise. And, the relative humidity risk may have a value, for example, on an hourly or other interval basis, as represented by Equation 14. In some examples, the relative humidity risk may have a value of 1 above a lower bound threshold (e.g., about 50%, etc.), and a value of 0 otherwise, on an hourly or other interval basis, etc. The temperature risk may then combined with the humidity risk (e.g., temp risk×RH risk, etc.) as desired (e.g., summed, averaged, etc.), etc.

temp_risk=1.0/(1.0+exp(−0.8*(t−12.5))), if t<25 1−(t−25)\hat{ }2/100, if 25<=t<=35 0, if t>35 where t is hourly temperature (13)

relative_humidity_risk=1.0/(1.0+exp(−0.27*(rh−77.5))) where rh is hourly relative humidity (14)

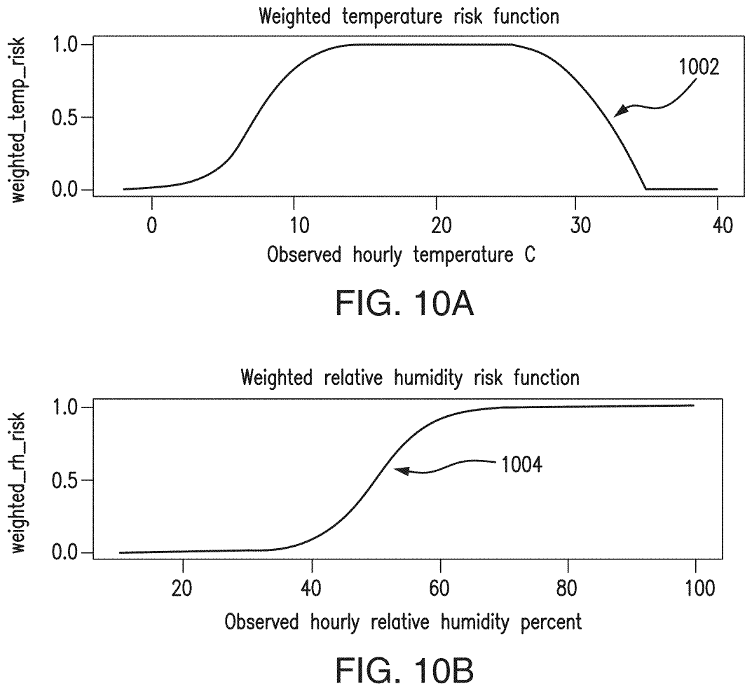

It should be appreciated that the integer values 0 and 1 are not the only way to represent the risk associated with temperature and relative humidity. The severity risk may be, for example, a continuation risk function based on the temperature and/or relative humidity. Table 3, for example, defines the risk values as continuous values, which are illustrated in the graphical representations in FIGS. 10A-10B. As shown in FIG. 10A, the plot 1002 illustrates a continuous risk of leaf rust based on temperature, and in FIG. 10B, the plot 1004 illustrates the continuous risk of leaf rust based on relative humidity.

TABLE 3
Weighted hourly weather risk

| | Temperature | Relative | Temp × |
|---|---|---|---|
| | risk | humidity risk | RH risk |
| Parameters | Temp_min: 0 | Rh_min: 70% | |
| | Temp_opt_min: 15 | Rh_opt: 85% | |
| | Temp_opt_max: 25 | | |
| | Temp_max: 35 | | |
| Risk | Less than temp_min: 0 | Sigmoid | Temp risk × |
| formula | [Temp_min, | function | RH risk |
| | temp_opt_max]: | | |
| | sigmoid | | |
| | [Temp_opt_max, | | |
| | temp_max]: | | |
| | quadratic | | |
| | Greater than | | |
| | temp_max = 0 | | |

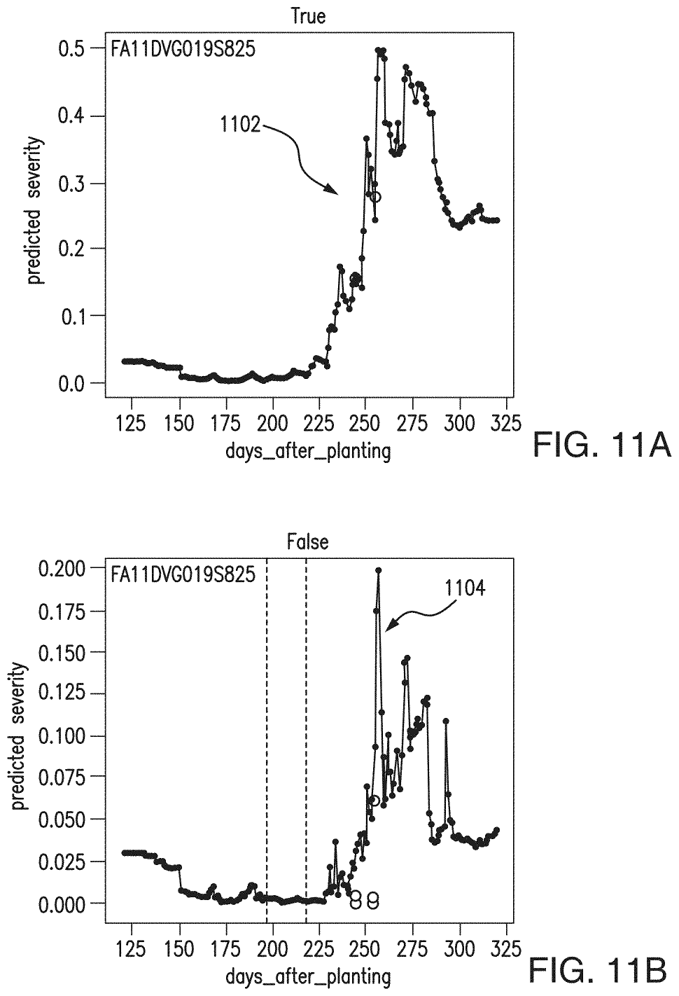

Based on the data features, as expressed above (e.g., continuous, binary, etc.), the agricultural computer system 130 is programmed or configured to determine leaf rust risk associated with the specific crop in the field 105. In particular, the agricultural computer system 130 is configured or programmed to cumulate the risk for the crop, from planting until the current date, whereby the daily risk (or hourly or other interval of risk) for the crop, based on the above thresholds for the different data features, is summed to provide an overall risk of leaf rust for the crop in the field 105. Generally, the summed risk is positively correlated with predicted severity. The summed risk and other features (e.g., fungicide application information such as time and ingredient(s), etc.) are provided into a random forest algorithm that aggregates the result of many decision trees to produce a single predicted severity. In connection therewith, FIGS. 11A-11B illustrate the risk probability, based on the above, of the severity of leaf rust for the crop. As shown in FIG. 11A, the risk 1102 increases, and continues to increase at about 225 days after planting for a TRUE or control field (for which there is no treatment applied), as compared to the risk 1104 illustrated in FIG. 11B for which the field 105 is treated at the dotted lines.

In this way, in connection with predicting disease risk (e.g., for leaf rust, etc.) on a particular date, if there was a particular fungicide application in the past within a last 20-30 days, etc., the leaf rust model 506 may configure or program the agricultural computer system 130 to determine a relatively low risk for the disease. However, if the particular fungicide application was done in the past more than 30 days ago, the leaf rust model 506 may be used (e.g., may configure or program the agricultural computer system 130, etc.) to interpret the fungicide effect to have run off and determine a relatively higher risk for the disease.

In this manner, the agricultural computer system 130 is configured or programmed, by the leaf rust model 506, to determine a daily severity risk of leaf rust infection in the crop in the field 105, for each of the synthetic sprays.

It should be appreciated that, while the severity of leaf rust is determined through the leaf rust model 506 in this embodiment, the occurrence of leaf rust may also, or alternatively, be determined through a different version(s) of the model(s) and combined, and then used to determine a predicted response as described below.

Stripe Rust Model

The stripe rust model 508 configures or programs (or is implemented in) the agricultural computer system 130 to determine a daily severity risk of the stripe rust (or yellow rust) disease for winter wheat in the field 105 from the current date forward for a given year. The severity risk of stripe rust may be provided on any desired scale, for example, low, medium, high, etc.

In this example embodiment, the stripe rust model 508 is defined based on the random forest model, which is dependent on temperature and the relative humidity. That said, it should be appreciated that other feature data may form the basis for the stripe rust model 508 in other embodiments, including, without limitation, other weather data, fungicide applications (e.g., chemistry, date, etc.), genetic disease susceptibility, soil data, topographic data, tillage data, rotation data, irrigation data, etc. With respect to the stripe rust model 508, for the specific data herein, the model relies on the temperature risk where the risk has a value, for example, on an hourly or other interval basis, as represented by Equation 15. In some examples, the temperature risk may have a value of 1 in a specific temperature range (e.g., between about 15° C. and about 25° C., etc.), and a value of 0 otherwise. And, the relative humidity risk may have a value, for example, on an hourly or other interval basis, as represented by Equation 16. In some examples, the relative humidity risk may have a value of 1 above a lower bound threshold (e.g., about 50%, etc.), and a value of 0 otherwise, on an hourly or other interval basis, etc. The temperature risk may then be combined with the humidity risk (e.g., temp risk×RH risk, etc.) as desired, etc. (e.g., summed, averaged, etc.).

temp_risk=1.0/(1.0+exp(−1*(t−7))), if t<15 1−(t−25)\hat{ }2/100, if 15<=t<=23 0, if t>23 where t is hourly temperature (15)

relative_humidity_risk=1.0/(1.0+exp(−0.27*(rh−77.5))) where rh is hourly relative humidity (16)

It should be appreciated that the binary values 0 and 1 are not the only way to represent the risk associated with temperature and relative humidity in the stripe rust model 508. The risk may be, for example, a continuation risk function based on the temperature and/or relative humidity. Like for leaf rust, Table 4, for example, defines the risk values as continuous values.

TABLE 4
Weighted hourly weather risk

| | Temperature | Relative | Temp × |
|---|---|---|---|
| | risk | humidity risk | RH risk |
| Parameters | Temp_min: 5 | Rh_min: 70% | |
| | Temp_opt_min: 9 | Rh_opt: 85% | |
| | Temp_opt_max: 15 | | |
| | Temp_max: 23 | | |
| Risk | Less than temp_min: 0 | Sigmoid | Temp risk × |
| formula | [Temp_min, | function | RH risk |
| | temp_opt_max]: | | |
| | sigmoid | | |
| | [Temp_opt_max, | | |
| | temp_max]: | | |
| | quadratic | | |
| | Greater than | | |
| | temp_max = 0 | | |

Based on the data features, as expressed above (e.g., continuous, binary, etc.), the agricultural computer system 130 is programmed or configured to determine stripe rust risk associated with the specific crop in the field 105. In particular, the agricultural computer system 130 is configured or programmed to cumulate the risk for the crop, from planting until the current date, whereby the daily risk (or hourly or other interval risk) for the crop based on the above thresholds for the different data features is summed to provide an overall risk of stripe rust for the crop in the field 105.

In this way, in connection with predicting disease risk (e.g., for stripe rust, etc.) on a particular date, if there was a particular fungicide application in the past within a last 20-30 days, etc., the stripe rust model 508 may be used (e.g., may configure or program the agricultural computer system 130, etc.) to determine a relatively low risk for the disease. However, if the particular fungicide application was done in the past more than 30 days ago, the stripe rust model 508 may consider (e.g., may configure or program the agricultural computer system 130 to interpret, etc.) the fungicide effect to have run off and determine a relatively higher risk for the disease.

In this manner, the agricultural computer system 130 is configured to programmed, by the stripe rust model 508, to determine a daily severity risk of stripe rust infection in the crop in the field 105, for each of the synthetic sprays.

It should be appreciated that, while the severity of stripe rust is determined through the stripe rust model 508 in this embodiment, the occurrence of stripe rust may also, or alternatively, be determined through a different version(s) of the model and combined, and then used to determine a predicted response as described below.

Fusarium Model

The Fusarium model 510 configures or programs (or is implemented in) the agricultural computer system 130 to determine a risk of Fusarium occurring around flowering time for winter wheat, for example, in the field 105 from the current date forward for a given year. The risk associated with Fusarium, generally, relates to quality of the crop (and not necessarily quantity of yield) and is represented, typically, as either present or not present, for example.

With reference again to FIG. 5, when each of the above models is executed, for each synthetic spray, the agricultural computer system 130 is configured or programmed to combine the outputs from the disease models 504, 506, 508 and 510, into a disease prediction output. The disease prediction output includes an experiment ID for the synthetic spray, a date of the synthetic application of the treatment, and the disease probabilities (e.g., predicted severity of each disease, etc.) based on time. Stated another way, the disease risk is based on whether or not the severity exceeds one or more disease specific thresholds (e.g., looking forward seven days, forward to harvest or ripening, etc.).

That said, while the architecture 500 includes four disease models 504-510, it should be appreciated that a different number and/or type of disease models may be used in other embodiments. For example, a region in which the field 105 is located may have limited or no risk of leaf rust, whereby the leaf rust model may be omitted, or the type of crop may be different whereby the number and/or type of disease models may be specific to the crop. As such, the example disease model should not be understood to be required, but are provided for purposes of illustration.

Response Model

From the output from the disease models in FIG. 5, the agricultural computer system 130 is configured or programmed, by the architecture 500, to execute the response model 512, in order to determine the response of the crop, and specifically, a yield response, to the synthetic sprays for the field 105. The response is determined, in this embodiment, as a delta, or difference, between the crop performance, which is predicted in consideration of the proposed synthetic spray, relative of the control prediction for the crop. The control prediction for the crop may include the crop without any treatment, or depending on the growth stage, the crop subject to only prior treatments. For example, when a grower opted to treat the field 105 in spray window T1, the control for a synthetic spray in the spray window T2 will include the crop, as already impacted by the spray in spray window T1.

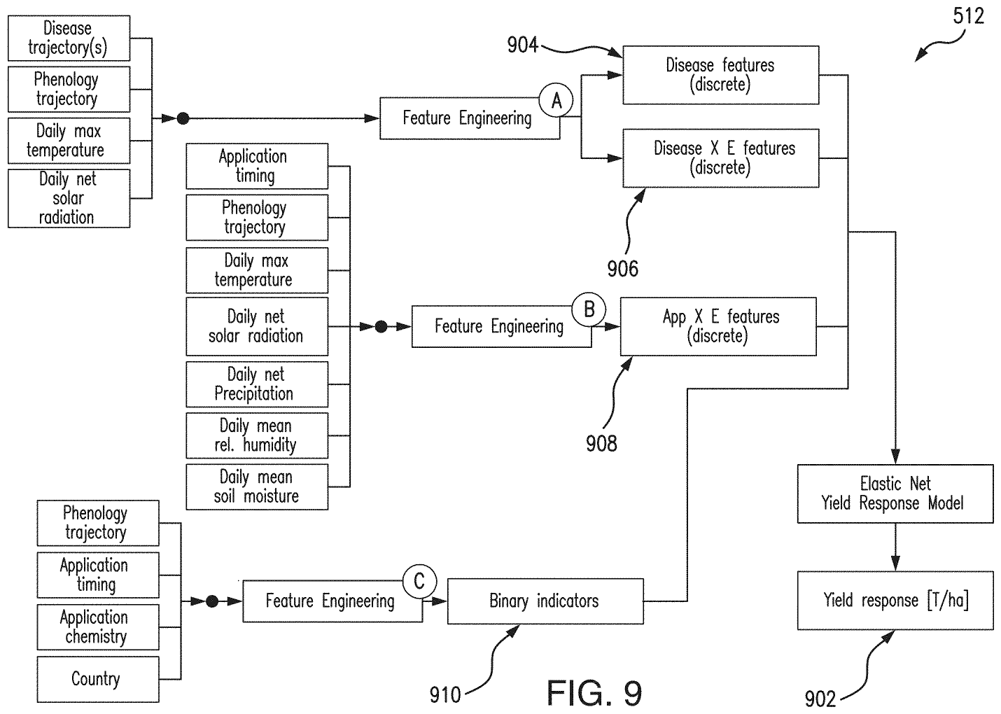

FIG. 9 illustrates a block diagram of the input data processing to be provided in advance of the response model 512. As shown in FIG. 9, specifically, the response model 512 includes three separate phases of data inputs, generally designated A, B, and C (and each identified as feature engineering), where A is a disease component of the model 512, B is an application component of the model 512, and C is a phenology component of the model 512. Each of the other, prior models provide data into the response model 512 as shown, and subject to feature engineering, as described. Consistent with FIG. 9, the agricultural computer system 130 is programmed or configured, by the response model 512, to determine a yield response, at 902, through use of the model 512.

Specifically, the response model 512 relies on certain data, which is defined as feature engineering in each of the three stages. In phase A, for example, the feature engineering includes a specific expression of the disease time series data. For example, the disease time series output (e.g., trajectory(ies), etc.) from one or more of the models 504-510 is defined as an input, where the predicted disease severity delta between the control crop and the treated crop (i.e., by the synthetic spray) is determined for each BBCH in the phenology trajectory, between the current day and the day of the synthetic spray, and beyond to harvest. This is performed for each disease for which a model is provided (e.g., Septoria, leaf rust, etc.). And then, the predicted severity of the control is also determined for each BBCH, between the current day and harvest. The input data, based on the above, to the response model 512 is represented in the block 904 in FIG. 9. Also, for disease in phase A, disease data is also combined with the weather data, where for each BBCH, between the current day and the day of harvest (or dates associated with a specific disease), the severity delta between the control crop and the treated crop is multiplied or otherwise combined with the weather data (e.g., maximum temperature, daily net solar radiation, etc.), and then summed to define further input data to the response model 512, which is represented in the block 906 in FIG. 9. This input data may be repeated for each of the relevant diseases.

With continued reference to FIG. 9, in phase B, the application specific input data is a combination of the identified input data, through feature engineering. In this example, for a given spray window (e.g., T1, T2, and T3, etc.), the net weather for each of the days from before a prior application to after the prior application is determined, and summed to the weather feature list for the application in the specific spray window. Similarly, the cumulative penalized thermal time for the application (e.g., synthetic treatment, synthetic spray, etc.) is determined for the specific spray window. Together, the data forms the input data for the prior application represented at block 908 in FIG. 9. And, also, as shown in phase C, the input data to the response model 512 also includes input data based on the application timing, application chemistry and location of the field 105. In particular, the input data is defined as the binary indicator for the country code and a frac code for the chemistry applied in the specific spray window (e.g., T1, T2, or T3, etc.) (e.g., frac code 7 in spray window T2, etc.), etc. In this way, the input data accounts for real time data indicative of applications (e.g., synthetic treatments, synthetic sprays, etc.), in particular spray windows, by way of the specific mode of action (as defined by the frac code) and/or chemistry associated with the given application. In other words, the response model 512 accounts for whether a treatment was applied or not (e.g., in a binary yes/no manner, etc.), as well as the particular treatment when applied, in real time in moving forward with determining the yield response. The input data is represented by the block 910 in FIG. 9.

It should be appreciated that the feature engineering employed with the response model 512 permits training of the model consistent with the data defined by the feature engineering.

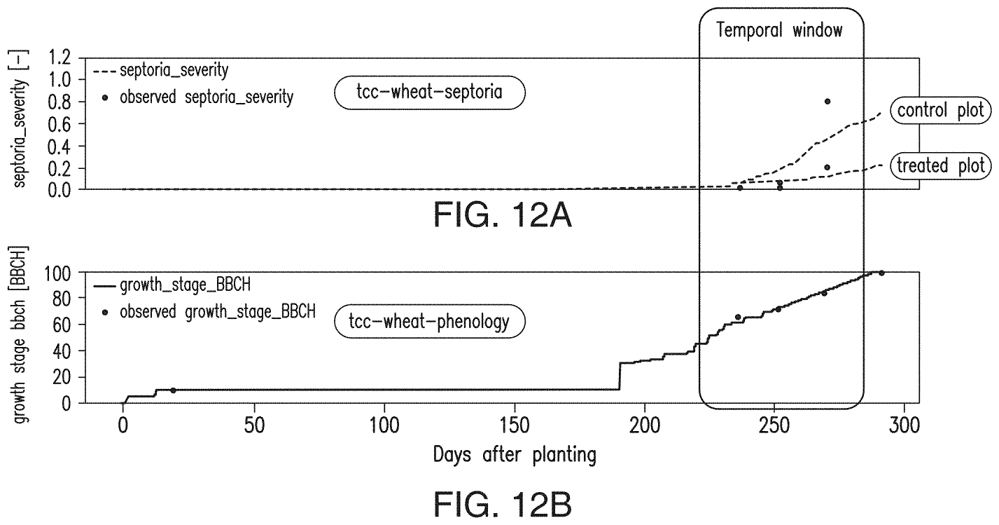

Given the above, and based on the defined input data, the agricultural computer system 130 is programmed or configured to determine the yield response for each synthetic spray, via the response model 512. In particular, the agricultural computer system 130 is programmed or configured to rely on the time series representation of the various data identified above. In one example, related to the input data at 904, Table 5 illustrates the relative time series expressions, which are then illustrated in FIGS. 12A-12B. Initially, a time series of the growth stage values for the control crop in field 105 is provided in FIG. 12B, while FIG. 12A illustrates the time series severity values for the control crop and the treated crop in field 105, whereby the severity delta is apparent. For a temporal window of 30 BBCH to 89 BBCH, the values for the control and severity deltas between the treated and the control crops are accumulated over the defined window and are then provided, which are then input data for the model 512.

TABLE 5

| | |
|---|---|
| X_{i, 0, t} | time-series growth stage values |
| | (plot at FIG. 12B) |
| X_{i, 1, t} | time-series severity values (plots in FIG. |
| | 12A), where there are two locations (i): |
| | control and (ii) treated plot |
| X_{i, 2, t} | time-series control plot severity values |
| X_{i, 3, t} = X_{i, 1, t} − X_{i, 2, t} | time-series treated - control plot severity |
| | values |
| temporal_window_{i, 0, 0} = ω_{0, 0, min} <= | temporal window based on (ω_{0, 0, min} = 30 \| |
| X_{i, 0, t} <= ω_{0, 0, max} for t in T | ω_{0, 0, maχ} = 89) |
| X^{d}_{i, 2, k} X^{d}_{i, 3, k} | discrete values for total control plot and |
| | treated - control plot severities accumulated |
| | over the growth stage period between BBCH |
| | 30 to 89 |

In connection with the above, it should be appreciated that weather is aggregated around spray application windows, rather than over an entire planting/growing season. It should also be appreciated that the input data herein may be impacted by domain expertise of users/growers/breeders associated with the architecture 500. In particular, for example, the discrete values herein (e.g., in Table 5, etc.) may be bounded by domain expertise. Further, in Table 5, X^{d}_{i, j, k} may have had time-series features engineered and compressed to discrete values per domain expertise, and may be ready to feed into a machine learning/artificial intelligence modeling framework such as described herein where feature interactions and temporal dependencies have been account for. In doing so, the users/growers/breeders may have added control over application of the features.

It should be appreciated that there are a variety of different ways to express the input data to the response model 512. The different input data is provided herein for purposes of illustration only and should not be understood to limit the present disclosure.

From the above, the input data with the discrete values bound by domain expertise and the illustrated feature engineering, may be exposed to a linear regression elastic net to provide the response model 512, as shown in FIG. 9. In the fitting of linear or logistic regression models, the elastic net includes a regularized regression method that may be implemented to linearly combine L1 and L2 penalties of the least absolute shrinkage and selection operator (lasso) and ridge methods. The elastic net may provide an extension of linear regression that adds regularization penalties to a loss function during training. In connection therewith, the elastic net may allow for a balance of both L1 and L2 penalties, which may result in improved performance over a model with only one or the other penalty.

It should be appreciated that other suitable models may be included or used such as, for example, a neural network or process model to build the response model as shown in FIG. 9, whereby the inputs are correlated to an appropriate output, etc.

That said, as shown in FIG. 9 again, the agricultural computer system 130 is configured or programmed to determine a yield response (at 902) of the synthetic spray, for each of the synthetic sprays, for the field 105, for example. As such, the agricultural computer system 130 provides a predicted yield response (e.g., in tons per hectare, etc.) of application of the treatment (e.g., fungicide, etc.), whereby the grower 102 is then permitted to make a decision related to when to apply the treatment (i.e., not only within a spray window, but for a specific day in the spray window. etc.).

In this example embodiment, the agricultural computer system 130 is programmed or configured to compile a report, for example, as shown in FIG. 5, at 524. And, the report may be transmitted to the grower 102, at device 104. The report may include a simple instruction as to the specific date in which the treatment should be applied to the field 105, or the report may include the predicted yield response for spraying the treatment on the different days in the spray windows. It should be appreciated that the grower 102 may be responsible for multiple fields, whereby the report may include options for applying treatment to multiple of the fields, each within a specific spray window and based on the predicted yield response, whereby the grower 102 is permitted to plan and/or coordinate applying the treatment to the different fields.

In this manner, the unique architecture 500 of FIG. 5, by relying on all available data, including daily weather data, and any prior applications to field, which drives the phenology model (at 502), prior to realizing the synthetic sprays relative to the various spray windows for the field, and predicting, based on the phenology, disease models, etc. the response of the field to the synthetic spray, provides a dynamic and complete assessment of when the application of a treatment should be made.

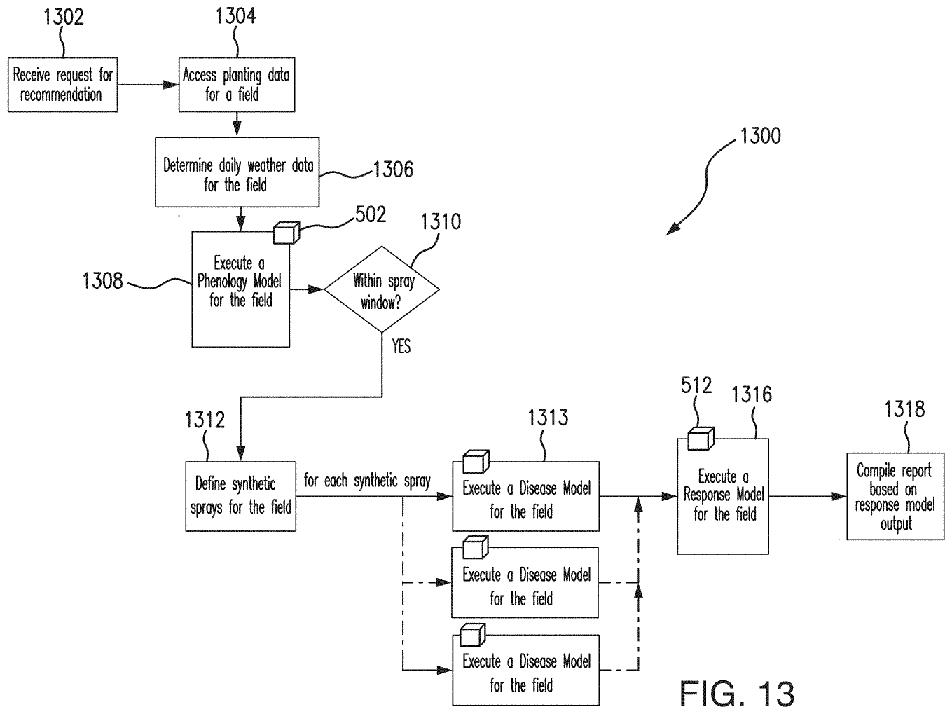

FIG. 13 depicts an example method 1300 for use in applying treatments to crops in growing spaces. The method 1300 is described in connection with the example system 100, and in particular, the agricultural computer system 130, and the example computing devices described herein. However, it should be appreciated that the method 1300 is not limited to the system 100, and may be implemented in a variety of different systems associated with agricultural fields related thereto and/or included therein. Likewise, the systems herein should not be understood to be limited to the example method 1300, or other methods described herein.

Initially in method 1300, the agricultural computer system 130 receives a request for a recommendation, at 1302. The request may be received from the grower 102, via the communication device 104, or from a treatment sales representative or entity, or other party/entity associated with the field 105, the crop included in the field 105 or the agricultural computer system 130, etc. The request, in general, includes an identification of the field 105, or other fields (as the request may be related to multiple fields, etc.), a description of the seed/crop planted in the field 105, a planting date for the field 105, and a location of the field 105 (e.g., in latitude and longitude, etc.). Alternatively, the request may include only an identification of the field 105, whereby the remaining data is accessed, as described below. It should be appreciated that the request may also include an identification of a treatment to be applied to the crop and/or field 105 (e.g., type, brand, ingredients, etc.), or other data indicative of the grower 102 or another party's preferences related to the treatment, etc.

As shown, at 1304, in response to the request, the agricultural computer system 130 accesses certain planting data for the field 105, and potentially other fields, included in the field data 106 and/or the external data 110, from memory associated with the agricultural computer system 130. The accessed planting data may include a location of the field 105, a planting date for a current crop included in the field 105, country codes for the country in which the field 105 is located (or another suitable region designation, etc.), a current year, a previous crop and/or variety of crop in the field 105, tillage methods used in prior years, etc. The accessed data may also include data related to prior applications of treatments to the field 105 (e.g., by product name, identifier, trade name, etc.), prior applications of treatments for the instant crop, chemistry of the treatments to the field 105 and/or instant crop, application date(s) of treatments, and/or producer of the treatment, etc.

At 1306, the agricultural computer system 130 determines the daily weather for the field 105, from the planting date to the current date, and potentially, beyond. The daily weather is retrieved based on the location of the field 105 and the planting date (e.g., from the planting date and/or the request date, etc.), from the external data server computer 108 in this example embodiment, or other sources (e.g., including internal sources, etc.) in other embodiments. The daily weather includes, for example (on a per day or other available interval basis) temperature, relative humidity, precipitation, solar radiation, snow coverage, etc.

Thereafter, the agricultural computer system 130 executes, at 1308, the phenology model 502, relative to the above data, to determine a growth stage of the crop in the field 105. As explained in more detail above, the agricultural computer system 130, through the phenology model 502, determines a thermal time for the crop in the field 105, and adjusts the thermal time based on various factors. The growth stage may be correlated with the thermal time associated with the crop. In other words, the aggregated thermal time may be indicative of the growth stage, which is provided in accordance with the BBCH index in this example embodiment. The output from the phenology model 502, may include a current date as well as data relating to the field ID for the field 105 and the historical weather year (e.g., field_id_historical_weather_year, which allows for identifying the field_id; etc.). The historical weather year may include a year to which the planting date for the field 105 has been shifted in order to run climatological simulations to extend a limited observed weather in order to get to an end of the season when making a forecast. For example, for a field having a field ID of “A”, the field_id_historical_weather_year of A_2016 and of A_2017 may be two different simulations for the given field, where the planting date was shifted to 2016 and 2017, respectively, for evaluation. The output from the phenology model 502 may further include an indication of how many thermal units have accumulated (e.g., cumulative_penalized_thermal_time_Cd, etc.) (or aggregated thermal time). Here, for example, under more favorable field conditions, plants in the field may have generally higher numbers of accumulated thermal units (e.g., generally higher values for cumulative_penalized_thermal_time_Cd, etc.) than under more unfavorable conditions.

At 1310, the agricultural computer system 130 determines if the crop, based on the growth stage, is within a predefined spray window for the crop, where the spray windows T1, T2, and T3 are defined in FIGS. 6A and 6B above, as time periods within which the growth stage for the crop is adequate for treatment, or otherwise depending on the particular crop, field, region, etc. When the agricultural computer system 130 determines that the crop is within the spray window (or approaching the spray window), the agricultural computer system 130 defines multiple synthetic sprays for the field 105, at 1312. The agricultural computer system 130 may define one synthetic spray for each day or based on another interval of the growth stage index, which defines the spray window, to generate another number of synthetic sprays suitable for the field 105, the crop, etc.

After the synthetic sprays are defined, the agricultural computer system 130 executes one or more disease models, at 1314. The number and type of disease models may vary depending on the crop included in the field 105, the region in which the field is located, environmental factors, etc. The variable number of disease model is illustrated in FIG. 13, as one disease model execution step is referenced 1314, and two other disease model execution steps are shown as optional in broken lines. The disease model(s) may include any of the disease models described herein (e.g., disease models 504-510, etc.) or other suitable model.

Each disease model will output a predicted occurrence and/or severity of the respective disease (in some examples, referred to together as disease risk), from the current date until a ripening/harvest date for the crop in the field 105 (e.g., a time series output, etc.). The output further includes an experiment identifier specific to the synthetic spray and a date of the synthetic spray. It should be appreciated that the disease risk is determined for each of the synthetic sprays, and also for a control experiment, which does not include a synthetic spray (e.g., but may include a prior actual spray, etc.). The risks associated with the different disease models, if any, are combined. Next, at 1316, the agricultural computer system 130 executes the response model 512, which defines a delta between the yield of the crop with the synthetic spray as compared to the yield of the crop without the synthetic spray, i.e., the control.

Consequently, the agricultural computer system 130 determines a yield delta for each of the defined synthetic sprays, which are combined into a report, at 1318, by the agricultural computer system 130. The report provides/illustrates a comparison of the synthetic sprays, and an associated yield delta over the control. The agricultural computer system 130 transmits the report to the grower 102, or other requestor, whereby the different sprays and/or spray times may be compared. What's more, because the report includes a yield delta (or difference) over the control, the grower 102, for example, is permitted to assess the value of the recommended treatment(s) to a resulting increase in revenue from sale of the crop after harvest (e.g., compare the cost of the treatment to the increase revenue from the treated crop over the untreated crop, etc.).

In one or more embodiment, the method 1300 includes applying the treatment to the field 105, consistent with the recommendation (or report), either automatically, as directed by the agricultural computer system 130, the communication device 104 or otherwise, or manually, by the grower 102, etc.

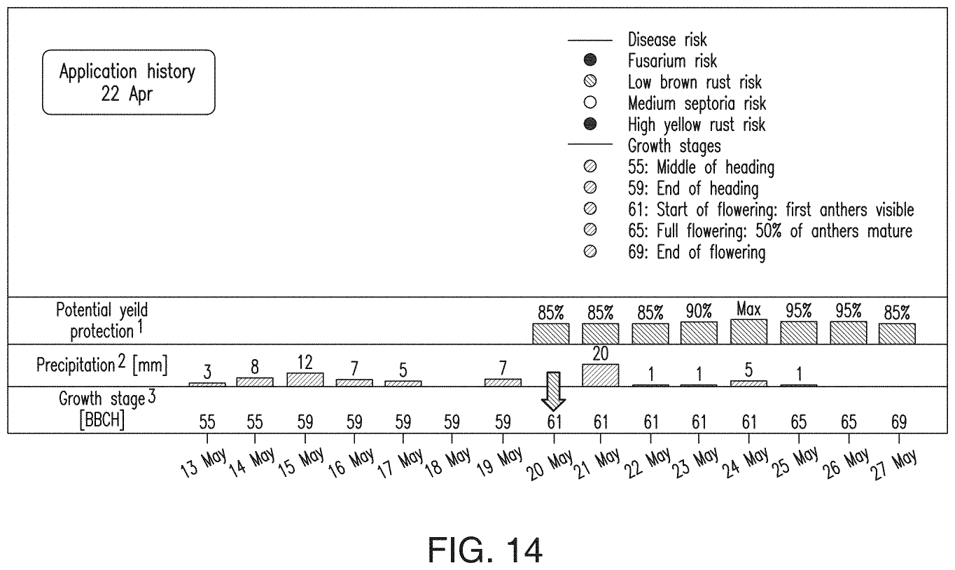

FIG. 14 illustrates an example report that may be generated by the agricultural computer system 130 in connection with determining a yield delta for each of a defined group of synthetic sprays (e.g., at 1318 in the method 1300, etc.). As shown, the report generally includes an indication of disease risk for the crop in the field (e.g., in field 105, etc.) for the given spray window (e.g., entering a spray window in the next 7 days, etc.) as well as the growth stages of the crop for the spray window. The report then identifies a potential yield protection percentage based on application of a treatment to the field at the specified day (e.g., potentially with an associated note in the report such as “Within each fungicide spray window (T1, T2, T3 as determined by growth stage), the MAX may extend more than one day. In these instances, please apply fungicide at the earliest date with no rainfall. Fungicide applications should be no more than one day outside of the ‘MAX’ window. Days outside of the ‘MAX’ window will be labeled as the estimated percentage of yield protection (0-95%).”; etc.). The report may also include a precipitation forecast for each of the days (e.g., potentially with an associated note in the report such as “Precipitation forecasts are supplied directly from Weather Company.”; etc.). And, taking into account the yield protection percentages, the precipitation forecast, and the growth stage, the report may further include a recommendation as to timing for application of the treatment (as indicated by the arrow at May 20). With the report, then, the grower (e.g., grower 102 in the system 100, etc.) can make a decision of when to spray, on a day indicated for max yield (e.g., May 24, etc.), or otherwise recommended in the report (e.g., May 20 as recommended, etc.).

That said, it should be appreciate that not all growers will be able to spray at a specific time, therefore the report may include the additional information for other days and associated days. In this way, the example report of FIG. 14 provides for a flexibility in the implementation of the methods and systems herein.

It should be appreciated that the architecture 500 of FIG. 5 and/or the method of 15 can be repeated or redone at any desired interval, for example, when the grower opts not to spray on a given day, whereby an updated report may be generated for a following day (or following 7 day period). In doing so, the models herein may account for additional real time data (e.g., changes in weather forecasts, etc.). Further, the architecture 500 of FIG. 5 and/or the method of 15 can be repeated or redone even when a spray treatment is provided to a field, for example, to identify timing of a future treatment, etc. In an embodiment, script generation instructions 205 can be used to generate performance instructions 135 for agricultural apparatus based on parameters of synthetic spray selected from the report, in particular timing, agrochemical (chemical or biological composition), application rate, etc. In an embodiment, grower can start script generation instructions 205, e.g. by way of selecting in the report displayed on user interface of communication device 104 synthetic spray to be conducted next. In an embodiment, the system 130 may collect data confirming synthetic spray is conducted and/or ask grower 102 for confirmation of treatment. In an embodiment, system 130 may reiterate the method described above for planning of next treatment in an automatic manner or on user request. In other words, the agricultural computer system provides a continued assistance in planning first and next treatment(s) and/or in generating instruction scripts for conducting treatment(s) to crops in the one or more fields based on synthetic spray selected from produced report(s) to be conducted next.

### EMBODIMENTS

For further illustration, and without limitation, additional embodiments of the present disclosure are set forth below.

Embodiment 1 is directed to a computer-implemented method for use in applying a treatment to crops in one or more fields (and/or for providing assistance in planning a treatment to crops in one or more fields), where the method includes one or more of: (a) receiving, at a computing device, a request to recommend an application of a treatment for a field, the field including a crop, which is associated with a planting date indicative of a day the crop was planted, the request including a field ID for the field; (b) accessing a data structure including planting data and weather data for the field; (c) calculating, by the computing device, a growth stage of the crop in the field on a defined date, via a phenology model, based on the planting data and weather data included in the data structure, the growth stage indicative of a thermal time associated with the crop as defined by multiple temperatures associated with the field from about the planting date to about the defined date; (d) determining, by the computing device, whether the calculated growth stage is within a spray (broadly, a treatment) window for the crop; (e) in response to the growth stage being within the spray window, defining a plurality of synthetic sprays (broadly, treatments) within the spray window for the field; and then (f) for each one of the plurality of synthetic sprays: (i) calculating, by the computing device, at least one disease risk for the crop in the field, based on at least one disease risk model, the at least one disease risk indicative of a potential occurrence and/or a severity of at least one disease; and/or (ii) calculating, by the computing device, a response to the synthetic spray, via a response model, based on the calculated at least one disease risk and the growth stage of the crop in the field, wherein the calculated response includes a yield difference between a predicted crop yield for the crop subject to the synthetic spray and the predicted crop yield for the crop without the synthetic spray; and then further (g) compiling, by the computing device, a report including a selected one or more of the calculated responses and/or a selected one or more synthetic sprays within a spray window for the field, based on the yield differences of the responses, as a recommendation for applying the treatment to the crop consistent with the synthetic spray associated with the selected one or more of the calculated responses; and (h) transmitting the report in response to the request.

Embodiment 2 is the computer-implemented method of Embodiment 1, further comprising applying, by an agricultural apparatus, in communication with the computing device, the treatment to the field consistent with the recommendation included in the report.

Embodiment 3 is the computer-implemented method of Embodiment 1 or Embodiment 2, wherein the crop includes winter wheat, and the treatment includes a fungicide.

Embodiment 4 is the computer-implemented method of any one of Embodiments 1-3, wherein accessing the data structure includes accessing the planting data in the data structure specific to the field based on the field ID.

Embodiment 5 is the computer-implemented method of any one of Embodiments 1-4, further comprising determining daily weather for the field based on the planting data and the weather data, the weather data including observed actual weather data for the field and forecasted weather data for the field; and/or wherein the growth stage is based on the daily weather for the field, from the planting date to the defined date, and at least one stress factor for the field.

Embodiment 6 is the computer-implemented method of any one of Embodiments 1-5, wherein the at least one disease model includes one or more of: a Septoria model, a leaf rust model, a stripe rust model, and a Fusarium model.

Embodiment 7 is the computer-implemented method of any one of Embodiments 1-6, wherein the at least one disease risk model is based on one or more of: daily temperature, average temperature for an interval, daily relative humidity, average relative humidity for an interval, and a combination of temperature and relative humidity.

Embodiment 8 is the computer-implement method of any one of Embodiments 1-7, wherein the at least one disease risk includes a time series severity risk of the disease from the defined date to a harvest date for the crop.

Embodiment 9 is directed to a non-transitory computer readable storage medium including executable instructions for use in identifying treatments for application to crops in one or more fields, which when executed by at least one processor, cause the at least one processor to: (a) receive a request to recommend an application of a treatment for a field, the field including a crop, which is associated with a planting date indicative of a day the crop was planted, the request including a field ID for the field; (b) access a data structure including planting data and weather data for the field; (c) calculate a growth stage of the crop in the field on a defined date, via a phenology model, based on the planting data and weather data included in the data structure, the growth stage indicative of a thermal time associated with the crop as defined by multiple temperatures associated with the field from about the planting date to about the defined date; (d) determine whether the calculated growth stage is within a spray window for the crop; (e) in response to the growth stage being within the spray window, define a plurality of synthetic sprays within the spray window for the field; and then (f) for each one of the plurality of synthetic sprays: (i) calculate at least one disease risk for the crop in the field, based on at least one disease risk model, the at least one disease risk indicative of a potential occurrence and/or a severity of at least one disease; and/or (ii) calculate a response to the synthetic spray, via a response model, based on the calculated at least one disease risk and the growth stage of the crop in the field, wherein the calculated response includes a yield difference between a predicted crop yield for the crop subject to the synthetic spray and the predicted crop yield for the crop without the synthetic spray; and then further (g) compile a report including a selected one or more of the calculated responses, based on the yield differences of the responses, as a recommendation for applying the treatment to the crop consistent with the synthetic spray associated with the selected one or more of the calculated responses; and (h) transmit the report in response to the request.

Embodiment 10 is the non-transitory computer readable storage medium of Embodiment 9, wherein the executable instruction, when executed by the at least one processor, further cause the at least one processor to cause an agricultural apparatus, in communication with the at least one processor, to apply the treatment to the field consistent with the recommendation included in the report.

Embodiment 11 is the non-transitory computer readable storage medium of Embodiment 9 or Embodiment 10, wherein the executable instruction, when executed by the at least one processor, further cause the at least one processor to determine daily weather for the field based on the weather data, the weather data including observed actual weather data for the field, forecasted weather data for the field, and climatology data associated with the field.

Embodiment 12 is the non-transitory computer readable storage medium of any one of Embodiments 9-11, wherein the at least one disease risk includes a time series severity risk of the disease from the defined date to a harvest date for the crop.

Embodiment 13 is the non-transitory computer readable storage medium of any one of Embodiments 9-12, wherein the at least one disease risk model is based on one or more of: daily temperature, average temperature for an interval, daily relative humidity, average relative humidity for an interval, and a combination of temperature and relative humidity.

Embodiment 14 is the non-transitory computer readable storage medium of any one of Embodiments 9-13, wherein the at least one disease risk model includes multiple of: a Septoria model, a leaf rust model, a stripe rust model, and a Fusarium model.

Embodiment 15 is directed to a system for use in identifying treatments for crops in one or more fields, the system comprising: (A) a data structure including planting data and weather data associated with multiple fields; and (B) at least one computing device coupled in communication to the data structure, the at least one computing device configured to: (i) receive a request to recommend an application of a treatment for a field, the field including a crop, which is associated with a planting date indicative of a day the crop was planted, the request including a field ID for the field; (ii) access the planting data and the weather data for the field in the data structure; (iii) calculate a growth stage of the crop in the field on a defined date, via a phenology model, based on the planting date and weather data included in the data structure, which is indicative of a thermal time associated with the crop as defined by temperatures associated with the field from about the planting date to about the defined date; (iv) determine whether the calculated growth stage is within a spray window for the crop; (v) in response to the growth stage being within the spray window, define a plurality of synthetic sprays within the spray window for the field; and then (vi) for each one of the plurality of synthetic sprays: (a) calculate at least one disease risk for the crop in the field, based on at least one disease risk model, the at least one disease risk indicative of a potential occurrence and/or a severity of at least one disease; and/or (b) calculate a response to the synthetic spray, via a response model, based on the calculated at least one disease risk and the growth stage of the crop in the field, wherein the calculated response includes a yield difference between a predicted crop yield for the crop subject to the synthetic spray and the predicted crop yield for the crop without the synthetic spray; and then (vii) compile a report including a selected one or more of the calculated responses, based on the yield differences of the responses, as a recommendation for applying the treatment to the crop consistent with the synthetic spray associated with the selected one or more of the calculated responses; and (viii) transmit the report in response to the request.

Embodiment 16 is the system of Embodiment 15, wherein the at least one computing device is further configured to determine daily weather for the field based on the planting data and the weather data; and/or wherein the weather data includes observed actual weather data for the field, forecasted weather data for the field, and climatology data associated with the field.

Embodiment 17 is the system of Embodiment 15 or Embodiment 16, wherein the at least one disease model includes one or more of: a Septoria model, a leaf rust model, a stripe rust model, and a Fusarium model.

Embodiment 18 is the system of any one of Embodiments 15-17, wherein the at least one disease risk model is based on one or more of: daily temperature, average temperature for an interval, daily relative humidity, average relative humidity for an interval, and a combination of temperature and relative humidity; and/or wherein the at least one disease risk includes a time series severity risk of the disease from the defined date to a harvest date for the crop.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: the claimed limitations. For example, the technical effect of the above-described embodiments of the disclosure may be achieved by performing at least one of the following operations: (a) receiving a request to recommend an application of a treatment for a field, the field including a crop, which is associated with a planting date indicative of a day the crop was planted, the request including a field ID for the field; (b) accessing a data structure including planting data and weather data for the field; (c) calculating, by the computing device, a growth stage of the crop in the field on a defined date, via a phenology model, based on the planting data and weather data included in the data structure, the growth stage indicative of a thermal time associated with the crop as defined by multiple temperatures associated with the field from about the planting date to about the defined date; (d) determining, by the computing device, whether the calculated growth stage is within a window for the crop; (e) in response to the growth stage being within the window, defining a plurality of synthetic treatments within the window for the field; (f) for each one of the plurality of synthetic treatments: (i) calculating, by the computing device, at least one disease risk for the crop in the field, based on at least one disease risk model, the at least one disease risk indicative of a potential occurrence and/or a severity of at least one disease; and (ii) calculating, by the computing device, a response to the synthetic treatment, via a response model, based on the calculated at least one disease risk and the growth stage of the crop in the field, wherein the calculated response includes a yield difference between a predicted crop yield for the crop subject to the synthetic treatment and the predicted crop yield for the crop without the synthetic treatment; (g) compiling, by the computing device, a report including a selected one or more of the calculated responses, based on the yield differences of the responses, as a recommendation for applying the treatment to the crop consistent with the synthetic treatment associated with the selected one or more of the calculated responses; and (h) transmitting the report in response to the request.

With that said, example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in applying a treatment to crops in one or more fields, the method comprising:
receiving, at a computing device, a request to recommend an application of a treatment for a field, the field including a crop, which is associated with a planting date indicative of a day the crop was planted, the request including a field ID for the field;
accessing a data structure including planting data and weather data for the field;
calculating, by the computing device, a growth stage of the crop in the field on a defined date, via a phenology model, based on the planting data and weather data included in the data structure, the growth stage indicative of a thermal time associated with the crop as defined by multiple temperatures associated with the field from about the planting date to about the defined date;
determining, by the computing device, whether the calculated growth stage is within a window for the crop;
in response to the growth stage being within the window, defining a plurality of synthetic treatments within the window for the field; and then
for each one of the plurality of synthetic treatments:
calculating, by the computing device, at least one disease risk for the crop in the field, based on at least one disease risk model, the at least one disease risk indicative of a potential occurrence and/or a severity of at least one disease; and
calculating, by the computing device, a response to the synthetic treatment, via a response model, based on the calculated at least one disease risk and the growth stage of the crop in the field, wherein the calculated response includes a yield difference between a predicted crop yield for the crop subject to the synthetic treatment and the predicted crop yield for the crop without the synthetic treatment; and then
compiling, by the computing device, a report including a selected one or more of the calculated responses, based on the yield differences of the responses, as a recommendation for applying the treatment to the crop consistent with the synthetic treatment associated with the selected one or more of the calculated responses; and
transmitting the report in response to the request.

2. The computer-implemented method of claim 1, further comprising applying, by an agricultural apparatus, in communication with the computing device, the treatment to the field consistent with the recommendation included in the report, wherein the report further includes an indication of the treatment.

3. The computer-implemented method of claim 2, wherein the crop includes winter wheat, and the treatment includes a fungicide.

4. The computer-implemented method of claim 2, wherein accessing the data structure includes accessing the planting data in the data structure specific to the field based on the field ID.

5. The computer-implemented method of claim 1, further comprising determining daily weather for the field based on the planting data and the weather data, the weather data including observed actual weather data for the field and forecasted weather data for the field; and
wherein the growth stage is based on the daily weather for the field, from the planting date to the defined date, and at least one stress factor for the field.

6. The computer-implemented method of claim 1, wherein the at least one disease model includes one or more of: a Septoria model, a leaf rust model, a stripe rust model, and a Fusarium model.

7. The computer-implemented method of claim 1, wherein the at least one disease risk model is based on one or more of: daily temperature, average temperature for an interval, daily relative humidity, average relative humidity for an interval, and a combination of temperature and relative humidity.

8. The computer-implement method of claim 7, wherein the at least one disease risk includes a time series severity risk of the disease from the defined date to a harvest date for the crop.

9. A non-transitory computer readable storage medium including executable instructions for use in identifying treatments for application to crops in one or more fields, which when executed by at least one processor, cause the at least one processor to:
receive a request to recommend an application of a treatment for a field, the field including a crop, which is associated with a planting date indicative of a day the crop was planted, the request including a field ID for the field;
access a data structure including planting data and weather data for the field;
calculate a growth stage of the crop in the field on a defined date, via a phenology model, based on the planting data and weather data included in the data structure, the growth stage indicative of a thermal time associated with the crop as defined by multiple temperatures associated with the field from about the planting date to about the defined date;
determine whether the calculated growth stage is within a window for the crop;
in response to the growth stage being within the window, define a plurality of synthetic treatments within the window for the field; and then
for each one of the plurality of synthetic treatments:
calculate at least one disease risk for the crop in the field, based on at least one disease risk model, the at least one disease risk indicative of a potential occurrence and/or a severity of at least one disease; and
calculate a response to the synthetic treatment, via a response model, based on the calculated at least one disease risk and the growth stage of the crop in the field, wherein the calculated response includes a yield difference between a predicted crop yield for the crop subject to the synthetic treatment and the predicted crop yield for the crop without the synthetic treatment; and then
compile a report including a selected one or more of the calculated responses, based on the yield differences of the responses, as a recommendation for applying the treatment to the crop consistent with the synthetic treatment associated with the selected one or more of the calculated responses; and
transmit the report in response to the request.

10. The non-transitory computer readable storage medium of claim 9, wherein the executable instruction, when executed by the at least one processor, further cause the at least one processor to cause an agricultural apparatus, in communication with the at least one processor, to apply the treatment to the field consistent with the recommendation included in the report.

11. The non-transitory computer readable storage medium of claim 9, wherein the executable instruction, when executed by the at least one processor, further cause the at least one processor to determine daily weather for the field based on the weather data, the weather data including observed actual weather data for the field, forecasted weather data for the field, and climatology data associated with the field.

12. The non-transitory computer readable storage medium of claim 9, wherein the at least one disease risk includes a time series severity risk of the disease from the defined date to a harvest date for the crop.

13. The non-transitory computer readable storage medium of claim 9, wherein the at least one disease risk model is based on one or more of: daily temperature, average temperature for an interval, daily relative humidity, average relative humidity for an interval, and a combination of temperature and relative humidity.

14. The non-transitory computer readable storage medium of claim 13, wherein the at least one disease risk model includes multiple of: a Septoria model, a leaf rust model, a stripe rust model, and a Fusarium model.

15. A system for use in identifying treatments for crops in one or more fields, the system comprising:
a data structure including planting data and weather data associated with multiple fields; and
at least one computing device coupled in communication to the data structure, the at least one computing device configured to:
receive a request to recommend an application of a treatment for a field, the field including a crop, which is associated with a planting date indicative of a day the crop was planted, the request including a field ID for the field;
access the planting data and the weather data for the field in the data structure;
calculate a growth stage of the crop in the field on a defined date, via a phenology model, based on the planting date and weather data included in the data structure, which is indicative of a thermal time associated with the crop as defined by temperatures associated with the field from about the planting date to about the defined date;
determine whether the calculated growth stage is within a window for the crop;
in response to the growth stage being within the window, define a plurality of synthetic treatments within the window for the field; and then
for each one of the plurality of synthetic treatments:
calculate at least one disease risk for the crop in the field, based on at least one disease risk model, the at least one disease risk indicative of a potential occurrence and/or a severity of at least one disease; and
calculate a response to the synthetic treatment, via a response model, based on the calculated at least one disease risk and the growth stage of the crop in the field, wherein the calculated response includes a yield difference between a predicted crop yield for the crop subject to the synthetic treatment and the predicted crop yield for the crop without the synthetic treatment; and then
compile a report including a selected one or more of the calculated responses, based on the yield differences of the responses, as a recommendation for applying the treatment to the crop consistent with the synthetic treatment associated with the selected one or more of the calculated responses; and
transmit the report in response to the request.

16. The system of claim 15, wherein the at least one computing device is further configured to determine daily weather for the field based on the planting data and the weather data; and
wherein the weather data includes observed actual weather data for the field, forecasted weather data for the field, and climatology data associated with the field.

17. The system of claim 16, wherein the at least one disease model includes one or more of: a Septoria model, a leaf rust model, a stripe rust model, and a Fusarium model.

18. The system of claim 15, wherein the at least one disease risk model is based on one or more of: daily temperature, average temperature for an interval, daily relative humidity, average relative humidity for an interval, and a combination of temperature and relative humidity; and/or
wherein the at least one disease risk includes a time series severity risk of the disease from the defined date to a harvest date for the crop.
